(19) United States
(12) Patent Application Publication
(10) Pub. No.: US 2026/0024261 A1
(43) Pub. Date: Jan. 22, 2026

(54) SERVER, DISPLAY DEVICE AND DIGITAL HUMAN PROCESSING METHOD

(71) Applicant: Hisense Visual Technology Co., Ltd., Shandong (CN)

(72) Inventors: Hong MA, Shandong (CN); Shansong YANG, Shandong (CN); Ming MA, Shandong (CN); Ruiping FENG, Shandong (CN); Shao LIU, Shandong (CN); Xiang LU, Shandong (CN); Bing WANG, Shandong (CN); Jianjun WANG, Shandong (CN); Lize ZHANG, Shandong (CN); Na Wang, Shandong (CN); Aiguo FU, Shandong (CN); Wei LIU, Shandong (CN)

(21) Appl. No.: 19/335,909

(22) Filed: Sep. 22, 2025

Related U.S. Application Data
(63) Continuation of application No. PCT/CN2024/096157, filed on May 29, 2024.

(30) Foreign Application Priority Data
Jun. 25, 2023 (CN) 202310758892.0
Sep. 27, 2023 (CN) 202311256230.X
Sep. 27, 2023 (CN) 202311256277.6
Sep. 27, 2023 (CN) 202311258706.3
Sep. 27, 2023 (CN) 202311259355.8
Sep. 27, 2023 (CN) 202311267720.X

(51) Int. Cl. G06T 13/20; G10L 13/02; G10L 13/08; G10L 17/06; G10L 25/63

(52) U.S. Cl. CPC G06T 13/205; G10L 13/02; G10L 13/08; G10L 17/06; G10L 25/63

(57) ABSTRACT

A server is provided. The server is configured to: receive speech data input from a user and sent from a display apparatus; recognize the speech data to obtain a recognition result; based on that the recognition result includes entity data, obtain media resource data corresponding to the recognition result, and digital human data corresponding to the entity data; wherein the entity data includes a human name and/or a media resource name, the digital human data includes image data and a broadcast speech of a digital human, and the media resource data includes audio and video data or interface data; and send the digital human data and the media resource data to the display apparatus for the display apparatus to play the audio and video data or display the interface data, and play an image and a speech of the digital human according to the digital human data.

### CROSS-REFERENCE TO RELATED APPLICATIONS

The present disclosure is a continuation application of International Application No. PCT/CN2024/096157, filed on May 29, 2024, which claims priorities to Chinese Patent Application No. 202310758892.0, filed on Jun. 25, 2023; Chinese Patent Application No. 202311256230.X, filed on Sep. 27, 2023; Chinese Patent Application No. 202311256277.6, filed on Sep. 27, 2023; Chinese Patent Application No. 202311259355.8, filed on Sep. 27, 2023; Chinese Patent Application No. 202311267720.X, filed on Sep. 27, 2023; and Chinese Patent Application No. 202311258706.3, filed on Sep. 27, 2023, all of which are hereby incorporated by reference in their entiretics.

### TECHNICAL FIELD

The present disclosure relates to the technical field of digital human interaction, and particularly to a server, a display apparatus and a digital human processing method.

### BACKGROUND

With the continuous development of artificial intelligence technology, digital human has become a technology of great concern. Digital human is a virtual character generated by computer programs and algorithms, can simulate human language, behavior, emotion and other characteristics, and is highly intelligent and interactive. At present, digital human technology is mainly applied to games, education, medical treatment, finance and other fields.

Application scenarios of digital human are relatively single, mainly limited to a single scenario, such as virtual anchor news broadcast, educational video lecturer, etc. Digital human avatar display is also relatively single, only replacing the traditional voice assistant avatar. A user selects the selectable digital human avatar.

### SUMMARY

In a first aspect, some embodiments of the present disclosure provide a server, which may be configured to: receive speech data input from a user and sent from a display apparatus; recognize the speech data to obtain a recognition result; based on that the recognition result includes entity data, obtain media resource data corresponding to the recognition result, and digital human data corresponding to the entity data; wherein the entity data includes a human name and/or a media resource name, the digital human data includes image data and a broadcast speech of a digital human, and the media resource data includes audio and video data or interface data; and send the digital human data and the media resource data to the display apparatus for the display apparatus to play the audio and video data or display the interface data, and play an image and a speech of the digital human according to the digital human data.

In a second aspect, some embodiments of the present disclosure provide a display apparatus, which may include: a display, configured to display an image and/or a user input interface: a user input interface, configured to receive a command from a user; a Bluetooth module, configured to perform an operation related to a Bluetooth protocol; a communicating device, configured to communicate with an external device according to a predetermined protocol; a memory, configured to store computer instructions and data associated with the display apparatus; at least one processor, connected with the display, the user input interface, the Bluetooth module, the communicating device and the memory, and configured to execute the computer instructions to cause the display apparatus to perform: receiving speech data input from the user; sending the speech data to a server through the communicating device; receiving digital human data sent from the server based on the speech data; and playing an image and a speech of the digital human according to the digital human data.

In a third aspect, some embodiments of the present disclosure provide a digital human processing method, which may include: receiving speech data input from a user and sent from a display apparatus; recognizing the speech data to obtain a recognition result; based on that the recognition result includes entity data, obtaining media resource data corresponding to the recognition result, and digital human data corresponding to the entity data, wherein the entity data includes a human name and/or a media resource name, the digital human data includes image data and a broadcast speech of a digital human, and the media resource data includes audio and video data or interface data; and sending the digital human data and the media resource data to the display apparatus for the display apparatus to play the audio and video data or display the interface data, and play an image and a speech of the digital human according to the digital human data.

### BRIEF DESCRIPTION OF FIGURES

FIG. 1 is a schematic diagram of an operation scenario between a display apparatus and a control device according to some embodiments;

FIG. 2 is a schematic diagram of a hardware configuration of a control device according to some embodiments;

FIG. 3 is a schematic diagram of a hardware configuration of a display apparatus according to some embodiments;

FIG. 4 is a schematic diagram of a software configuration of a display apparatus according to some embodiments;

FIG. 5 is another schematic diagram of a software configuration of a display apparatus according to some embodiments;

FIG. 6 is a flowchart of digital human interaction according to some embodiments;

FIG. 7 is a schematic diagram of a digital human entrance interface according to some embodiments;

FIG. 8 is a schematic diagram of a digital human selection interface according to some embodiments;

FIG. 9 is a flowchart for displaying a digital human interface according to some embodiments;

FIG. 10 is a flowchart for an adding digital human interface according to some embodiments;

FIG. 11 is a schematic diagram of a video recording preparation interface according to some embodiments;

FIG. 12 is a schematic diagram of a timbre setting interface according to some embodiments;

FIG. 13 is a schematic diagram of an audio recording preparation interface according to some embodiments;

FIG. 14 is a schematic diagram of a digital human naming interface according to some embodiments;

FIG. 15 is a schematic diagram of another digital human selection interface according to some embodiments;

FIG. 16 is a flowchart of a digital human customization according to some embodiments;

FIG. 17 is another flowchart of digital human interaction according to some embodiments;

FIG. 18 is a schematic diagram of a live data pushing process according to some embodiments;

FIG. 19 is a schematic diagram of a user interface according to some embodiments;

FIG. 20 is another digital human interaction sequence diagram according to some embodiments;

FIG. 21 is another flowchart of digital human interaction according to some embodiments;

FIG. 22 is a flowchart of generating a digital human avatar model according to some embodiments;

FIG. 23 is a schematic diagram of another digital human data playing interface according to some embodiments;

FIG. 24 is another flowchart of digital human interaction according to some embodiments;

FIG. 25 is a schematic diagram of another digital human data playing interface according to some embodiments;

FIG. 26 is a schematic diagram of another digital human data playing interface according to some embodiments;

FIG. 27 is a schematic diagram of another digital human data playing interface according to some embodiments;

FIG. 28 is a schematic diagram of another digital human data playing interface according to some embodiments;

FIG. 29 is a flowchart of performing speech interaction by a server according to some embodiments;

FIG. 30 is a schematic diagram of an emotion speech model according to some embodiments;

FIG. 31 is a flowchart of obtaining an emotion type and an emotion intensity according to some embodiments;

FIG. 32 is a schematic diagram of another emotion speech model according to some embodiments;

FIG. 33 is another flowchart of digital human interaction according to some embodiments;

FIG. 34 is a schematic diagram of a personal center interface according to some embodiments;

FIG. 35 is a schematic diagram of a family relationship according to some embodiments;

FIG. 36 is a flowchart of voiceprint recognition according to some embodiments;

FIG. 37 is a schematic diagram of another digital human data playing interface according to some embodiments;

FIG. 38 is a schematic diagram of a digital human driving process according to some embodiments;

FIG. 39 is another schematic diagram of a digital human driving process according to some embodiments;

FIG. 40 is another schematic diagram of a digital human driving process according to some embodiments;

FIG. 41 is another schematic diagram of a digital human driving process according to some embodiments;

FIG. 42 is another schematic diagram of a digital human driving process according to some embodiments;

FIG. 43 is another schematic diagram of a digital human driving process according to some embodiments;

FIG. 44 is another schematic diagram of a digital human driving process according to some embodiments;

FIG. 45 is another schematic diagram of a digital human driving process according to some embodiments;

FIG. 46 is a schematic structural diagram of a chip system according to some embodiments.

### DETAILED DESCRIPTION

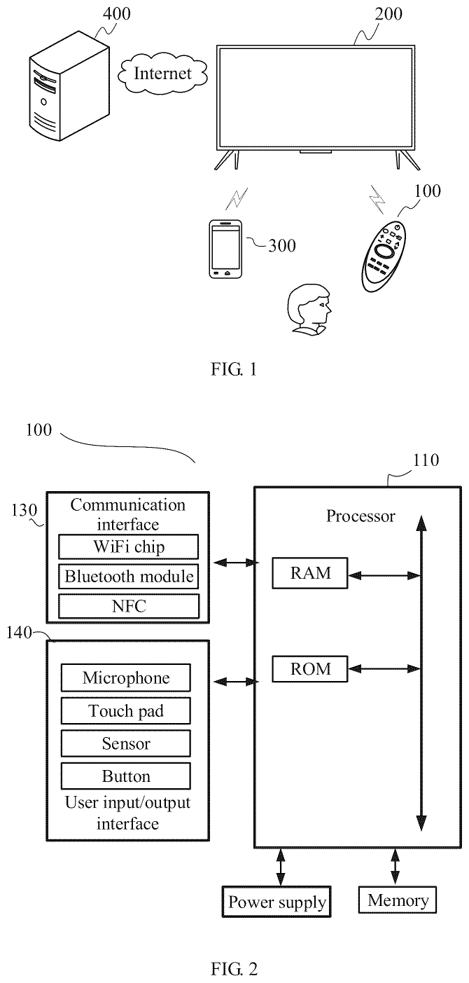

The display apparatus according to embodiments of the present disclosure may have various implementation forms, for example, the display apparatus may be a television, a smart television, a laser projection device, a monitor, an electronic bulletin board, an electronic table, or the like. FIG. 1 and FIG. 2 are embodiments of the display apparatus of the present disclosure.

FIG. 1 is a schematic diagram of an operation scenario between a display apparatus and a control apparatus according to embodiments. As shown in FIG. 1, a user may operate the display apparatus 200 through a terminal 300 or a control device 100.

In some embodiments, the control device 100 may be a remote control, and communication between the remote control and the display apparatus includes infrared protocol communication or Bluetooth protocol communication, or other short-range communication methods. The display apparatus 200 is controlled wirelessly or by wired methods. The user may control the display apparatus 200 by inputting a user command through a button on the remote control, a speech input, a control panel input, etc.

In some embodiments, the terminal 300 (such as a mobile terminal, a tablet computer, a computer, a notebook computer, etc.) may also be used to control the display apparatus 200. For example, the display apparatus 200 is controlled using an application running on the terminal.

In some embodiments, the display apparatus may not receive commands using the terminal or the control device described above. Instead, the user's control is received through touch, gesture, or the like.

In some embodiments, the display apparatus 200 may also be controlled by means other than the control device 100 and the terminal 300, for example, may directly receive a speech command control from a user via a module for obtaining a speech command provided inside the display apparatus 200, or may receive a speech command control from a user via a speech control device provided outside the display apparatus 200.

In some embodiments, the display apparatus 200 also performs data communication with a server 400. The display apparatus 200 may be allowed to perform communicative connection through a Local Area Network (LAN), a Wireless Local Area Network (WLAN), and other networks. The server 400 may provide various contents and interactions for the display apparatus 200. The server 400 may be a cluster or a plurality of clusters, including one or more types of servers.

FIG. 2 is a block diagram of a configuration of a control device 100 according to embodiments. As shown in FIG. 2, the control device 100 includes a processor 110, a communication interface 130, a user input/output interface 140, a memory, and a power supply. The control device 100 can receive an operation command input from a user and convert the operation command into a command that can be recognized and responded by the display apparatus 200, playing an intermediary role for interaction between the user and the display apparatus 200.

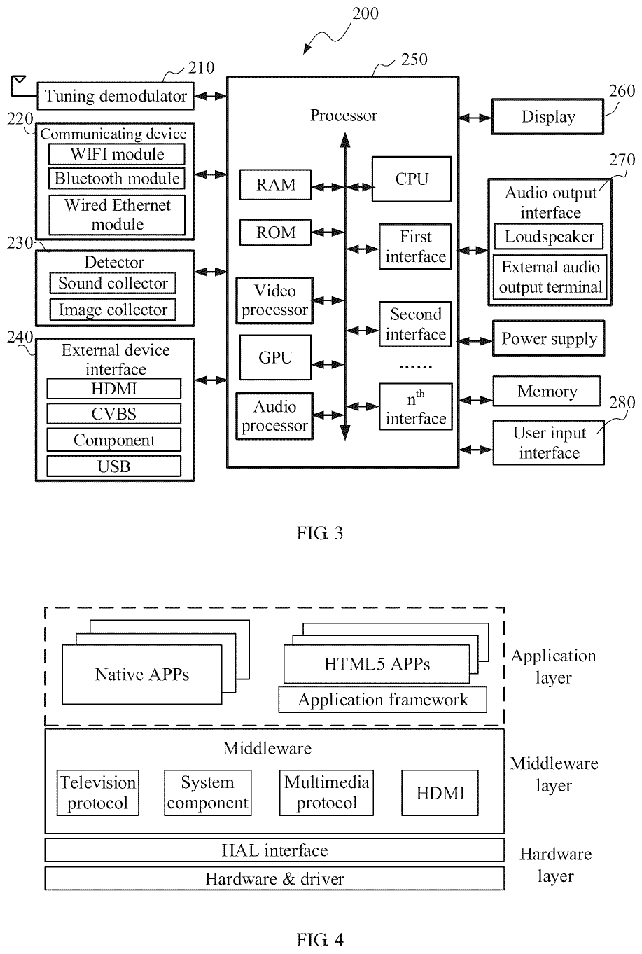

As shown in FIG. 3, the display apparatus 200 includes at least one of a tuning demodulator 210, a communicating device 220, a detector 230, an external device interface 240, a processor 250, a display 260, an audio output interface 270, a memory, a power supply, or a user input interface.

In some embodiments, the processor may include one or more processors, such as a video processor, an audio processor, a graphics processor, RAM, ROM, a first interface to an nth interface for input/output.

The display 260 includes a panel component for presenting an image, a driver component for driving image display, a component for receiving an image signal output from the processor, and for displaying video content, image content, a menu manipulation interface, and a UI for user operation, etc.

The display 260 may be a liquid crystal display, an OLED display, and a projection display, and may also be a projection device and a projection screen.

The display 260 may also include a touch screen, and the touch screen is used for receiving an action input control command such as swiping or clicking with a finger of a user on the touch screen.

The communicating device 220 is a component for communicating with an external apparatus or server according to various types of communication protocols. For example, the communicating device may include at least one of a WIFI module, a Bluetooth module, a wired Ethernet module, other network communication protocol chip or near-field communication protocol chip, or an infrared receiver. The display apparatus 200 may send and receive control signals and data signals with the control device 100 or the server 400 through the communicating device 220.

The user input interface is configured to receive a control signal from the control device 100 (e.g., an infrared remote controller).

The detector 230 is configured to collect a signal from an external environment or external interaction. For example, the detector 230 includes an optical receiver and a sensor for collecting environment light intensity; or, the detector 230 includes an image collector, such as a camera, which may be configured to collect an external environment scenario, a user attribute, or a user interaction gesture, or the detector 230 includes a sound collector, such as a microphone for receiving external sound.

The external device interface 240 may include, but is not limited to, any one or more of a high-definition multimedia interface (HDMI), an analog or data high-definition component input interface (Component), a composite video broadcast signal (CVBS) input interface, a USB input interface (USB), or an RGB terminal, or may be a composite input/output interface formed by a plurality of interfaces mentioned above.

The tuning demodulator 210 receives broadcasting television signals through wired or wireless reception, and demodulates audio and video signals from a plurality of wireless/wired broadcasting television signals, such as Electronic Program Guide (EPG) data signals.

In some embodiments, the processor 250 and the tuning demodulator 210 can be in different independent devices, that is, the tuning demodulator 210 can be in an external device of a primary device in which the control device 250 is located, such as an external set-top box, etc.

The processor 250 controls the operation of the display apparatus and responds to the user operation through various software control programs stored in the memory. The processor 250 controls the overall operation of the display apparatus 200. For example, in response to receiving a user command for selecting a UI object displayed on the display 260, the processor 250 can perform operations associated with the object selected based on the user command.

In some embodiments, the processor includes at least one of a Central Processing Unit (CPU), a video processor, an audio processor, a Graphics Processing Unit (GPU), a Random Access Memory (RAM), a Read Only Memory (ROM), a first interface to an nth interface for input/output, or a BUS.

The user can input user commands through a Graphical User Interface (GUI) displayed on the display 260. Then, the user input interface receives the user commands through the GUI. Alternatively, the user can input user commands through inputting specified speech or gestures. Then, the user input interface receives the user commands through a sensor recognizing the speech or gestures.

The “user interface” may be a medium interface for interaction and information exchange between an application or an operating system and a user, and convert information between an internal form and a form that is acceptable to the user. The common form of the user interface is Graphic User Interface (GUI), and is a graphically displayed user interface related to a computer operation. The user interface can be an icon, a window, a control and other interface elements displayed in a display screen of an electronic device. The control may include an icon, a button, a menu, a tab, a text box, a dialog box, a status bar, a navigation bar, a Widget, and other visual interface elements.

In some embodiments, as shown in FIG. 4, a system of the display apparatus may be divided into three layers, from top to bottom, which are an application layer, a middleware layer and a hardware layer.

The application layer mainly includes common applications on the television and an Application Framework. The common applications are mainly applications developed based on Browser, such as HTML5 applications (APPs) and native applications (Native APPs).

The Application Framework is a complete program model with all basic functions required by standard application software, such as file access, data exchange, etc., and a use interface of these functions (toolbar, status bar, menu, dialog box).

The native applications (Native APPs) can support online or offline, message push or local resource access.

The middleware layer includes middleware such as various television protocols, multimedia protocols, and system components. The middleware can use basic services (functions) provided by the system software, and link up various parts of the application system or different applications on the network, to achieve the purpose of resource sharing and function sharing.

The hardware layer mainly includes a Hardware Abstraction Layer (HAL) interface, hardware and drivers. The HAL interface is a unified interface for all television chips, and the specific logic is implemented by each of the chips. The drivers mainly include: an audio driver, a display driver, a Bluetooth driver, a camera driver, a WIFI driver, a USB driver, an HDMI driver, a sensor driver (such as a fingerprint sensor, a temperature sensor, a pressure sensor, etc.), and a power supply driver.

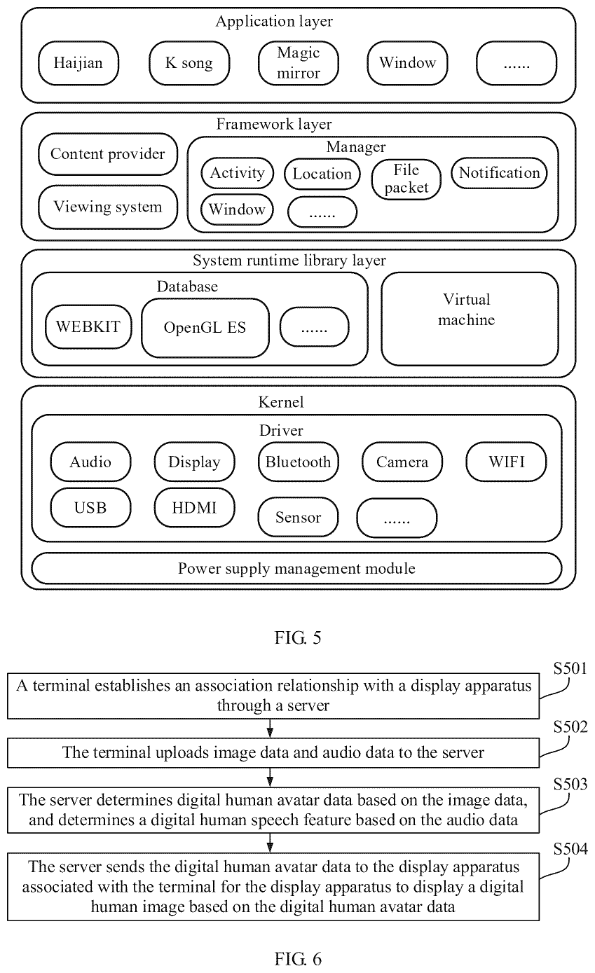

As shown in FIG. 5, in some embodiments, a system is divided into four layers from top to bottom, which are applications layer (application layer for short), application framework layer (framework layer for short), android runtime and system library layer (system runtime library layer for short) and Kernel layer.

In some embodiments, at least one application is run in the applications layer. The applications can be Window applications built in the operating system, system setting applications or clock applications and etc., and can be also applications developed by a third party. In an implementation, applications in the application layer include but not limit to aforementioned examples.

The framework layer provides the application programming interface (API) and programming frameworks to the applications in the applications layer. The application framework layer includes some predefined functions. The application framework layer corresponds to a processing center which decides actions of applications in the application layer. The applications can access resources of the system and obtain services from the system through the API.

As shown in FIG. 5, the application framework layer in embodiments of the present disclosure includes managers, a content provider and etc. The mangers include at least one of an activity manager configured to interact with all running activities, a location manager configured to provide system location service access to the system services or applications, a package manager configured to search various information relating to application packages installed on the device, a notification manager configured to display and remove notification messages, and a window manager configured to manage icons, windows, tool bars, wall papers and desk components on the user interface.

In some embodiments, the activity manager is configured to manage life cycle of an application and normal navigating back functions, such as controlling the functions of exit, open, back of applications, and etc. The window manager is configured to manage all window applications, for examples, obtaining the size of a display window, determining whether there is a status bar, locking screen, capturing screen, controlling a display window to change (e.g. zooming out the display window for display, dithering display, twisted deformation display, etc.).

In some embodiments, the system runtime library supplies support to a high layer, i.e., the framework layer. When the framework layer is used, the Android operation system runs C/C++ library included in the system runtime library layer to achieve functions of the framework layer.

In some embodiments, the Kernel layer is a layer between hardware and software, the Kernel layer includes at least one of drivers: an audio driver, a display driver, a Bluetooth driver, a camera driver, a WIFI driver, a USB driver, an HDMI driver, a sensor driver (such as a fingerprint sensor, a temperature sensor, a pressure sensor and etc.), or a power-supply driver, etc.

With the continuous development of artificial intelligence technology, digital human has become a technology of great concern. Digital human is a virtual character generated by computer programs and algorithms, can simulate human language, behavior, emotion and other characteristics, and is highly intelligent and interactive. At present, digital human technology is mainly applied to games, education, medical treatment, finance and other fields.

Application scenarios of digital human are relatively single, mainly limited to a single scenario, such as virtual anchor news broadcast, educational video lecturer, etc. Digital human avatar display is also relatively single, only replacing the traditional voice assistant avatar. A user selects the selectable digital human avatar.

Embodiments of the present disclosure provide a digital human processing method, as shown in FIG. 6, which may include following steps.

Step S501: A terminal 300 establishes an association relationship with a display apparatus 200 through a server 400.

In some embodiments, the server 400 establishes a connection relationship with the display apparatus 200 and the terminal 300 respectively, so that the display apparatus 200 establishes an association relationship with the terminal 300.

The step of the server 400 establishing the connection relationship with the display apparatus 200 may include: the server 400 establishes a long connection with the display apparatus 200.

The purpose of establishing the long connection between the server 400 and the display apparatus 200 is that the server 400 can push a customized state of a digital human to the display apparatus 200 in real time.

The long connection means that a plurality of packets can be sent continuously on a connection, and if no packet is sent during a connection hold period, both sides need to send link detection packets. The long connection only needs to establish one connection for a plurality of communications, saving network overhead. The long connection can maintain the communication state only by one handshake and authentication, improving the communication efficiency. The long connection can realize bi-directional data transmission, so that the server can actively send digital human customized data to the display apparatus, realizing the real-time communication effect.

In some embodiments, the server 400 establishes a long connection with the display apparatus 200 after receiving a power-on message from the display apparatus 200.

In some embodiments, the server 400 establishes a long connection with the display apparatus 200 after receiving a message that the display apparatus 200 enables a speech digital human service.

In some embodiments, the server 400 establishes a long connection with the display apparatus 200 after receiving an adding digital human command sent from the display apparatus 200.

The server 400 receives request data sent from the display apparatus 200. The request data may include a device identifier of the display apparatus 200.

After receiving the request data, the server 400 determines whether an identification code corresponding to the device identifier exists in a database. The identification code is used for representing device information of the display apparatus 200. The identification code may be a plurality of random numbers or letters, and may also be a bar code or a QR Code.

If the identification code corresponding to the device identifier exists in the database, the identification code is sent to the display apparatus 200 for the display apparatus 200 to display the identification code on an adding digital human interface.

If the identification code corresponding to the device identifier does not exist in the database, the identification code corresponding to the device identifier is created, the device identification and the identification code are correspondingly stored in the database, and the identification code is sent to the display apparatus 200 for the display apparatus 200 to display the identification code on the adding digital human interface.

In order to clarify the interactive process of establishing the connection between the server 400 and the display apparatus 200, following embodiments are disclosed.

After receiving a command for opening a digital human entrance interface input from a user, the display apparatus 200 controls the display 260 to display the digital human entrance interface. The digital human entrance interface may include a speech digital human control.

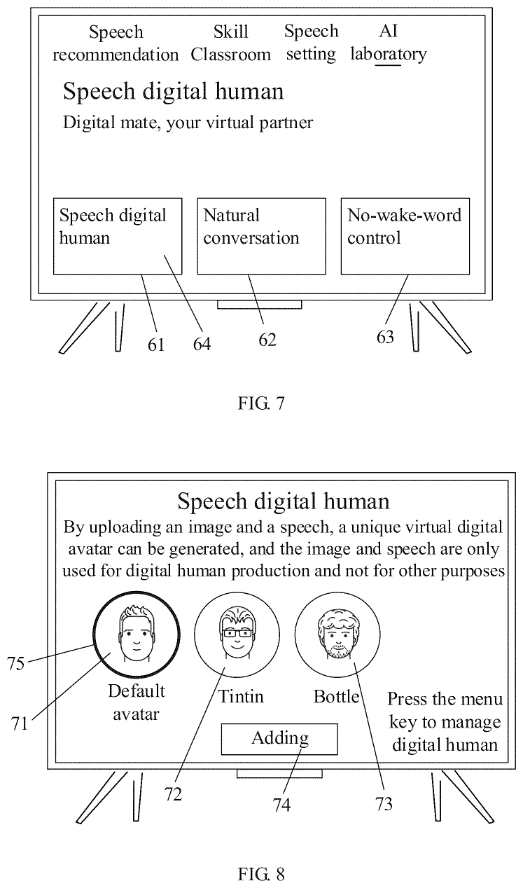

In some embodiments, as shown in FIG. 7, the digital human entrance interface may include a speech digital human control 61, a natural conversation control 62, a no-wake-word control 63, and a focus 64.

It should be noted that, a control refers to a visual object that is displayed in each presentation region of a user interface in the display apparatus 200 to represent corresponding content such as icon, thumbnail, video clip, link, etc. These controls may provide the user with a variety of traditional program content that is received through data broadcast, as well as a variety of applications and service content set by a content manufacturer.

The control is generally presented in a variety of forms. For example, the control may include text content and/or an image for displaying a thumbnail associated with the text content, or a text-related video clip. As another example, the control may be text and/or an icon of the application.

The focus is used for indicating that one of the controls has been selected. In one aspect, movement of a focus object displayed in the display apparatus 200 is controlled to select or control a control according to an input from a user through a control device 100. For example, the user can select and control a control through direction keys on the control device 100 to control the movement of the focus object between the controls. On the other hand, movement of controls displayed in the display apparatus 200 is controlled to cause the focus object to select or control a control according to the input from the user through the control device 100. For example, the user can control respective controls to move left and right together through direction keys on the control device 100, to cause the focus object to select and control the control while keeping the focus object's position unchanged.

The focus is generally identified in a variety of forms. Illustratively, a position of the focus object may be implemented or identified by zooming in an item. The position of the focus object may also be implemented or identified by setting a background color of the item. The position of the focus object may also be identified by changing a border line, size, color, transparency, and outline and/or font, etc., of text or image of a focused item.

After receiving a command for selecting a speech digital human control input from the user, the display apparatus 200 controls the display 260 to display a digital human selection interface. The digital human selection interface may include at least one digital human control and an adding control. The digital human control is displayed by a digital human avatar and a name corresponding to the digital human avatar. The adding control is used for adding a new digital avatar, timbre, and name.

In some embodiments, in FIG. 7, after the display apparatus 200 receives a command for selecting a speech digital human control 61 input from a user, the display apparatus 200 displays a digital human selection interface. As shown in FIG. 8, the digital human selection interface may include a default avatar control 71, a Tintin control 72, a bottle control 73, an adding control 74, and a focus 75. The user may select the desired digital human as the digital human responding to the speech command by moving the position of the focus 75.

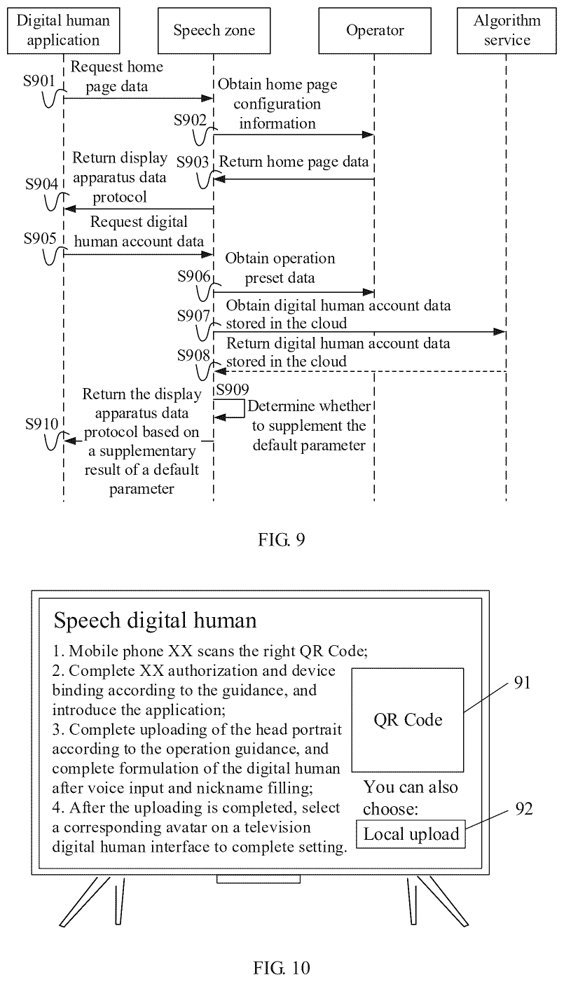

In some embodiments, the flow of displaying the digital human interface by the display apparatus 200 is as shown in FIG. 9, which may include following steps.

Step S901: A digital human application requests homepage data from a speech zone.

Step S902: The speech zone obtains configuration information of the homepage from the operator.

Step S903: The operator returns the homepage data to the speech zone.

Step S904: The speech zone returns a display apparatus data protocol to the digital human application.

Step S905: The digital human application requests digital human account data from the speech zone.

Step S906: The speech zone obtains operation preset data from the operator.

Step S907: The speech zone obtains the digital human account data stored in the cloud from an algorithm service.

Step S908: The algorithm service returns the digital human account data stored in the cloud to the speech zone.

Step S909: The speech zone determines whether to supplement a default parameter.

Step S910: The speech zone returns the display apparatus data protocol to the digital human application based on a supplementary result of the default parameter.

In steps S901-S910, after the digital human application of the display apparatus 200 receives a command for opening a digital human entrance interface (homepage) input from a user, the digital human application requests homepage data from the speech zone, and the speech zone obtains homepage configuration information (homepage data) from the operator. The speech zone sends the homepage data to the digital human application so that the digital human application controls the display 260 to display the digital human homepage. The digital human application may directly send a digital human account request. After receiving the virtual digital human account request, the speech zone obtains preset data, such as default digital human account information, from the operator. At the same time, the digital human account data stored in the cloud is obtained from the algorithm service of the server 400. If there is a default supplementary parameter, the preset data, the digital human account data stored in the cloud and the supplementary parameter are sent to the digital human application together. If there is no default supplementary parameter, the preset data and the digital human account data stored in the cloud are sent to the digital human application, so that the digital human application controls the display 260 to display the digital human selection interface after receiving a command for displaying the digital human selection interface. After the digital human homepage is displayed, the digital human application can also send a virtual digital human account request after receiving the command for displaying the digital human selection interface input from the user, and directly display the digital human selection interface after receiving the preset data, the digital human account data stored in the cloud and the supplementary parameter.

The speech zone faces the server 400, based on an operation support platform, realizes operation configurable management for a backend default data item and a configuration item, and completes protocol delivery of data required by the display apparatus 200. The speech zone is in series with the display apparatus 200 to interact with the algorithm service of the server 400, and through obtaining data parameters reported by the display apparatus 200, complete command analysis, complete algorithm backend interactive transfer, and analyze and issue backend storage data, to finally realize the data docking process of the whole link.

After receiving a command for selecting an adding control input from a user, the display apparatus 200 sends request data carrying the device identifier of the display apparatus 200 to a customized central control service of the server 400.

The customized central control service invokes a target application interface to determine whether an identification code corresponding to the device identifier exists in the database. If the identification code corresponding to the device identifier exists in the database, the identification code is sent to the display apparatus 200. If the identification code corresponding to the device identifier does not exist in the database, the identification code is created and sent to the display apparatus 200. The target application refers to an application with a function identifying an identification code.

The display apparatus 200 receives the identification code sent from the server 400, and displays the identification code on an adding digital human interface.

In some embodiments, in FIG. 8, after receiving a command for selecting an adding control 74 input from a user, the display apparatus 200 may display an adding digital human interface as shown in FIG. 10. The adding digital human interface may include a QR Code 91.

The step of the server 400 establishing the connection relationship with the terminal 300 may include: the server 400 receiving the identification code uploaded from the terminal 300; determining whether there is a display apparatus 200 corresponding to the identification code.

If the display apparatus 200 corresponding to the identification code exists, an association relationship between the terminal 300 and the display apparatus 200 is established, to send the data uploaded from the terminal 300 and processed by the server 400 to the display apparatus 200.

In order to clarify the interactive process of establishing a connection between the server 400 and the terminal 300, following embodiments are disclosed.

After receiving a command for opening a target application input from a user, the terminal 300 starts the target application and displays a homepage interface corresponding to the target application. The homepage interface may include a scanning control.

The terminal 300 displays a code scanning interface after receiving a command for selecting a scanning control input from the user.

After scanning the identification code displayed by the display apparatus 200, for example, the QR Code, the terminal 300 uploads the identification code to the server 400. The user can aim a camera of the terminal 300 at the identification code displayed in the adding digital human interface on the display apparatus 200.

If the identification code is in the form of numbers or letters, the homepage interface may include an identification code control. After receiving a command for selecting an identification code control input from a user, an identification code input interface is displayed. Numbers or letters displayed by the display apparatus 200 are input to the identification code input interface to upload the identification code to the server 400.

The server 400 determines whether a display apparatus corresponding to the identification code exists. If the display apparatus 200 corresponding to the identification code exists, an association relationship between the terminal 300 and the display apparatus 200 is established, to send data uploaded from the terminal 300 and processed by the server 400 to the display apparatus 200. If the display apparatus 200 corresponding to the identification code does not exist, an identification failure message is sent to the terminal 300, so that the terminal 300 displays an error message.

After determining that the display apparatus 200 corresponding to the identification code exists, the server 400 sends an identification success message to the terminal 300. The terminal 300 displays a start page. The start page starts to enter a digital human customization process.

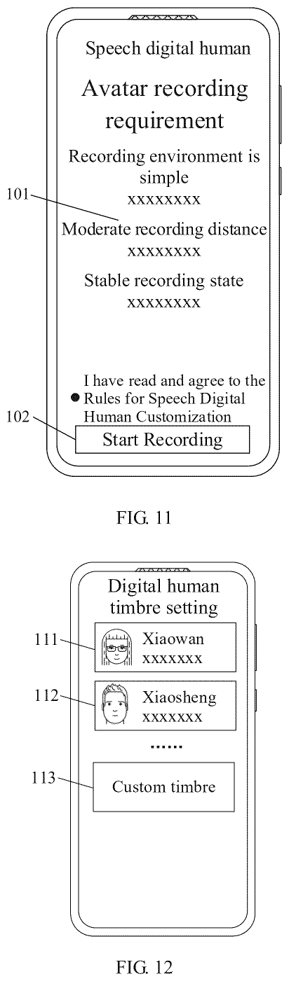

In some embodiments, the start page may include a digital human avatar selection interface. The digital human avatar selection interface includes at least one default avatar control and a custom avatar control. After receiving a command for selecting a custom avatar control input from a user, the terminal 300 displays a video recording preparation interface. The video recording preparation interface may include a recording control. In some embodiments, as shown in FIG. 11, the video recording preparation interface may include a video recording note 101 and a start recording control 102.

In some embodiments, the start page may also be a video recording preparation interface.

In some embodiments, the step of the terminal 300 establishing an association relationship with the display apparatus 200 through the server 400 may include: the server 400 receiving a user account and password uploaded from the terminal 300, and after verifying that the user account and password are correct, sending a message of successful login, so that the terminal 300 can obtain data corresponding to the user account.

The server 400 receives the user account and the password uploaded from the display apparatus 200, and after verifying that the user account and the password are correct, sends a message of successful login, so that the display apparatus 200 can obtain the data corresponding to the user account. The terminal 300 and the display apparatus 200 have the same login user account. The terminal 300 and the display apparatus 200 establish an association relationship by logging in the same user account, so that data updated from the terminal 300 can be synchronized to the display apparatus 200. For example, digital human related data customized at the terminal 300 may be synchronized to the display apparatus 200. Step S502: The terminal 300 uploads image data and audio data to the server 400.

The image data may include a video or image captured by a user, a video or image selected by the user from an album, and a video or image downloaded from a website address.

In some embodiments, the terminal 300 uploads the received video or image captured by the user to the server 400.

In some embodiments, in FIG. 11, after receiving a command for selecting a start recording control 102 input from a user, a video is recorded by using a media component video of the terminal 300. In order to avoid a plurality of recordings due to unqualified facial detection, a recording interface displays a suggested position of the face. The terminal 300 may perform preliminary detection on the position of the face. Recorded video can be previewed repeatedly after recording. After receiving a command for confirming uploading input from the user, the video recorded by the user is sent to the server 400.

In some embodiments, the terminal 300 may send a user photo captured to the server.

In some embodiments, the terminal 300 may select a user photo or a user video from an album, and upload the user photo or the user video to the server 400.

The server 400 receives image data uploaded from the terminal.

Whether a face point position in the image data is qualified is detected.

After receiving the image data uploaded from the terminal, the customized central control service invokes the algorithm service to verify the face point position.

If the face point position in the image data is detected to be qualified, an image detection qualification message is sent to the terminal 300.

If the face point position in the image data is detected to be unqualified, send an image detection disqualification message to the terminal, so that the terminal 300 prompts the user to re-upload.

The face point position detection may be to use an algorithm to detect whether key points of a face are within a specified region.

After receiving the image detection qualification message, the terminal 300 displays an online special effect page.

In the online special effect page, the user can upload the original video or the original photo to the server 400, that is, the original video or the original photo is used as the head portrait of the digital human. The user can also choose a style of a special effect liked by the user, drag or click an intensity of the special effect, and upload the video or photo after adopting the special effect to the server 400, that is, the video or photo after adopting the special effect is used as the head portrait of the digital human. In the process of making the special effect, the user can touch the lower right corner of the special effect image to compare the difference with the original image at any time. In the production of the special effect, image preloading is used to monitor a loading progress of an image resource and set a hierarchical relationship of images.

After the image data passes the face point position verification and is successfully uploaded to the server 400, the terminal 300 displays a timbre setting interface. The timbre setting interface may include at least one preset recommended timbre control and a custom timbre control.

After receiving a command for selecting a preset recommended timbre control input from a user, the terminal 300 sends an identifier corresponding to a preset recommended timbre to the server 400, and displays a digital human naming interface.

In some embodiments, after receiving a command for selecting a custom timbre control from a user input, the terminal 300 displays an audio recording selection interface, and the audio recording selection interface can include an adult control and a child control.

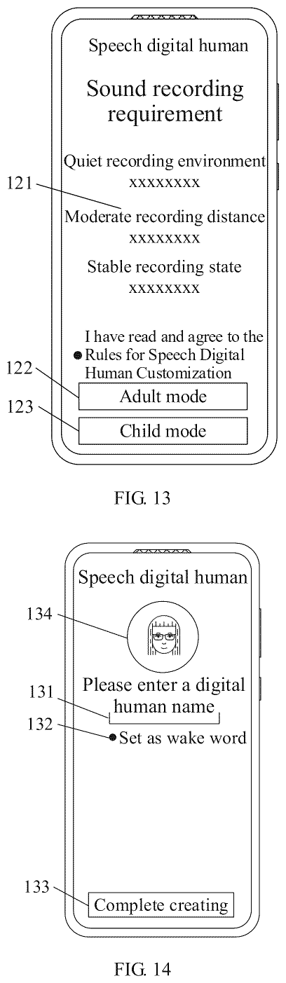

In some embodiments, as shown in FIG. 12, the timbre setting interface may include a Xiaowan control 111, a Xiaosheng control 112, and a custom timbre control 113. A command for selecting the custom timbre control 113 input from the user is received, and an audio recording preparation interface is displayed, as shown in FIG. 13. The audio recording selection interface may include a recording note 121, an adult control 122, and a child control 123. After receiving the user input to select the adult control 122 or the child control 123, respective corresponding processes are entered. A command for selecting the Xiaowan control 111 input from the user is received, and a digital human naming interface is displayed, as shown in FIG. 14.

The terminal 300 displays an environment sound detection interface after receiving a command for selecting an adult control input from the user.

The terminal 300 collects environment sound of a preset duration, and sends environment recording sound recorded by the user to the server 400.

The server 400 receives the environment recording sound uploaded from the terminal 300.

Whether the environment recording sound is qualified is detected.

After receiving the environment recording sound uploaded from the terminal 300, the customized central control service invokes the algorithm service to detect whether the environment recording sound is qualified.

The step of detecting whether the environment recording sound is qualified can include: obtaining a noise value of the environment recording sound; determining whether the noise value exceeds a preset threshold; if the noise value exceeds the preset threshold, determining that the environment recording sound is unqualified; if the noise value does not exceed the preset threshold, determining that the environment recording sound is qualified.

If it is detected that the environment recording sound is qualified, an environment sound qualification message and a target text required for audio recording are sent to the terminal 300.

If it is detected that the environment recording sound is not qualified, an environment sound disqualification message is sent to the terminal 300, so that the terminal 300 prompts the user to select a quiet space for re-recording.

After receiving the environment sound qualification message and the target text required for audio recording, the terminal 300 displays the target text. A text reflecting timbre characteristic of the user can be selected for the target text.

The terminal 300 receives audio of the target text read by the user, and sends the audio to the server 400. The terminal 300 may send the audio data to the server 400 upon receiving the audio data for a preset duration, so that the server 400 can send a recognition result back to the terminal 300 to achieve the effect of recognizing the reading text in real time.

The server 400 receives audio of the target text read by the user.

A user text corresponding to the audio is recognized.

A qualification rate is calculated according to the target text and the user text. The step of calculating the qualification rate according to the target text and the user text may

include: comparing the target text with the user text to obtain a quantity of correct characters in the user text; determining the qualification rate to be a ratio of the quantity of the correct characters to a quantity of characters in the target text.

Whether the qualification rate is less than a preset value is determined.

If the qualification rate is less than a preset value, a speech uploading failure message is sent to the terminal 300, so that the terminal 300 prompts the user to re-record the audio of the target text read by the user.

In some embodiments, when the text being read is recognized in real time, the target text is compared with the user text to determine wrong, over reading, and missed reading texts. The wrong, over reading, and missed reading texts are annotated and sent to the terminal 300, so that the terminal 300 displays the wrong, over reading, and missed reading texts in different colors or fonts.

If the qualification rate is not less than the preset value, a speech uploading success message is sent to the terminal 300, so that the terminal 300 displays a next target text or speech recording completion information.

After a preset quantity of target texts are read and qualified, the audio acquisition process ends, and the terminal 300 displays a digital human naming interface.

The server 400 receives audio data corresponding to the preset quantity of target texts.

After receiving a command for selecting a child control input from the user, the terminal 300 also displays an environment sound detection interface. The environment sound detection procedure is the same as when the adult control is selected.

If the environment sound record by the user is detect to be qualified, an environment sound qualification message and lead reading audio required for audio recording are sent to the terminal 300.

The terminal 300 can automatically play the lead reading audio for repeated trial listening. When receiving a command for pressing a recording key from the user, audio read by the user is started to be recorded, and the audio is sent to the server 400.

The server 400 receives the audio read by the user.

A user text corresponding to the audio is recognized.

A qualification rate is calculated according to a target text corresponding to the lead reading audio and the user text corresponding to the audio read.

Whether the qualification rate is less than a preset value is determined.

If the qualification rate is less than the preset value, a speech uploading failure message is sent to the terminal 300, so that the terminal 300 prompts the user to re-record the audio corresponding to the lead reading audio. When the text being read is recognized in real time, the target text is compared with the user text to determine wrong, over reading, and missed reading texts. The wrong, over reading, and missed reading texts are annotated and sent to the terminal 300, so that the terminal 300 displays the wrong, over reading, and missed reading texts in different colors or fonts.

If the qualification rate is not less than the preset value, a speech upload success message is sent to the terminal 300, so that the terminal 300 plays a next lead reading audio or speech recording completion information.

After receiving the speech recording completion information, the terminal 300 displays a digital human naming interface.

In some embodiments, after the terminal 300 receives a command for selecting a custom timbre control input from a user, a segment of audio data can be selected to be uploaded. The server 400 detects a noise value after receiving the audio data, and if the noise value exceeds a preset threshold, sends an uploading failure message to the terminal 300, so that the terminal 300 prompts the user to re-upload. If the noise value does not exceed the preset threshold, an uploading success message is sent to the terminal 300, so that the terminal 300 displays a digital human naming interface.

After receiving a digital human name input from the user, the terminal 300 sends the digital human name to the server 400.

In some embodiments, as shown in FIG. 14, the digital human naming interface may include an input box 131, a wake word control 132, a completion creation control 133, and a trained digital human avatar 134. The wake word control 132 is used for determining whether the digital human name is also set as a wake word for the display apparatus. If the wake word control 132 is selected, the digital human name is set as the wake word for the display apparatus 200. In some embodiments, rules for the digital human name set as the wake word for the display apparatus are as follows: the length is 4 to 5 Chinese characters, use of reduplicated words (such as “XiaoXiaoLeLe”) are avoided, colloquial words (such as “I'm back”) are avoided, sensitive words are avoided. If the wake word control 132 is not selected, the digital human name is not set as the wake word for the display apparatus. In some embodiments, rules for the digital human name not set as the wake word for the display apparatus 200 are as follows: the maximum length is 5 characters, Chinese, English and numbers can be used, and sensitive words are avoided. Digital human names created by a display apparatus or a user account cannot be repeated.

The digital human name is sent to the server 400 after receiving a command for selecting the completion creation control 133 input from the user. After detecting that the digital human name sent from the user is approved, the server 400 sends a message of creation success to the terminal 300. The terminal 300 may display prompt information of creation success. After detecting that the digital human name sent from the user is not approved, the server 400 sends a message of creation failure and a failure reason to the terminal 300. The terminal 300 may display prompt information indicating the reason for the creation failure and renaming.

Step S503: The server 400 determines digital human avatar data based on the image data, and determines a digital human speech feature based on the audio data.

Image preprocessing is performing on a second-level video or a user photo uploaded from a user to obtain digital human avatar data. Image preprocessing is a process of sorting out each image and sending the image to a recognition module. In image analysis, processing is performed on an input image prior to feature extraction, segmentation, and matching. The main purpose of image preprocessing is to eliminate irrelevant information in the image and restore useful real information, enhance detectability of relevant information and minimize data, improving reliability of feature extraction, image segmentation, matching and recognition. In embodiments of the present disclosure, the interactive avatar with high fidelity and high definition of the customize avatar is realized through relate algorithms.

In some embodiments, the digital human avatar data may include a 2D digital human avatar and facial key point coordinate information. The facial key point coordinate information provides data support for the key point drive of the digital human speech.

In some embodiments, the digital human avatar data may include digital human parameters, such as 3D BS (Blend Shape) parameters. The digital human parameters are offsets of facial key points provided on the basis of a basic model, so that the display apparatus 200 can draw the digital human avatar based on the basic model and the digital human parameters.

A speech clone model is trained by using audio data uploaded from the user, to obtain a timbre parameter conforming to a timbre of the user. During speech synthesis, the broadcast text can be input into a human speech clone model embedded with the timbre parameter, to obtain the broadcast speech conforming to the timbre of the user.

In order to support digital human speech interaction, embodiments of the present disclosure adds phoneme duration prediction on the basis of general speech synthesis speech architecture, for driving facial key points of the downstream digital human. In order to support digital human avatar customization, timbre customization with few samples is realized on the basis of multi-speaker speech synthesis model. Through 1 to 10 sentences of user speech samples, model parameters of a small quantity are fine-tuned to achieve speech cloning.

A real human avatar or a cartoon avatar can be selected for the digital human avatar, and creating a real human avatar or a cartoon avatar at the same time can also be selected for the digital human avatar.

When the server 400 receives image data (the face point position is not detected) uploaded from the terminal 300, training of the real human avatar or the cartoon avatar of the user can be notified, that is to say, real human avatar or cartoon avatar training and face point position detection are performed at the same time. If the face point position detection fails, the training of the real human avatar or the cartoon avatar is terminated. If the face point position detection is successful, waiting time for digital human training can be shortened.

In some embodiments, the server 400 sends the trained real human avatar and cartoon avatar to the terminal 300, so that the terminal 300 displays the digital human avatar for the user to select and use.

The terminal 300 receives and displays the trained real human avatar, provides for a user to perform operations such as beautifying and adding special effects on the real human avatar, and can also provide options such as making cartoon avatars and re-recording videos for the user to obtain the digital human avatar required.

Step S504: The server 400 sends the digital human avatar data to the display apparatus 200 associated with the terminal 300 for the display apparatus 200 to display a digital human image based on the digital human avatar data.

In some embodiments, the digital human image may be displayed in the digital human selection interface directly after the 2D digital human image is received.

In some embodiments, after the digital human parameters are received, a digital human image is drawn based on the basic model and the digital human parameters, and the digital human image is displayed on the digital human selection interface.

In some embodiments, the server 400 may also send the digital human name corresponding to the digital human avatar data to the display apparatus 200 associated with the terminal 300 for the display apparatus 200 to display the digital human name at the corresponding position of the digital human image.

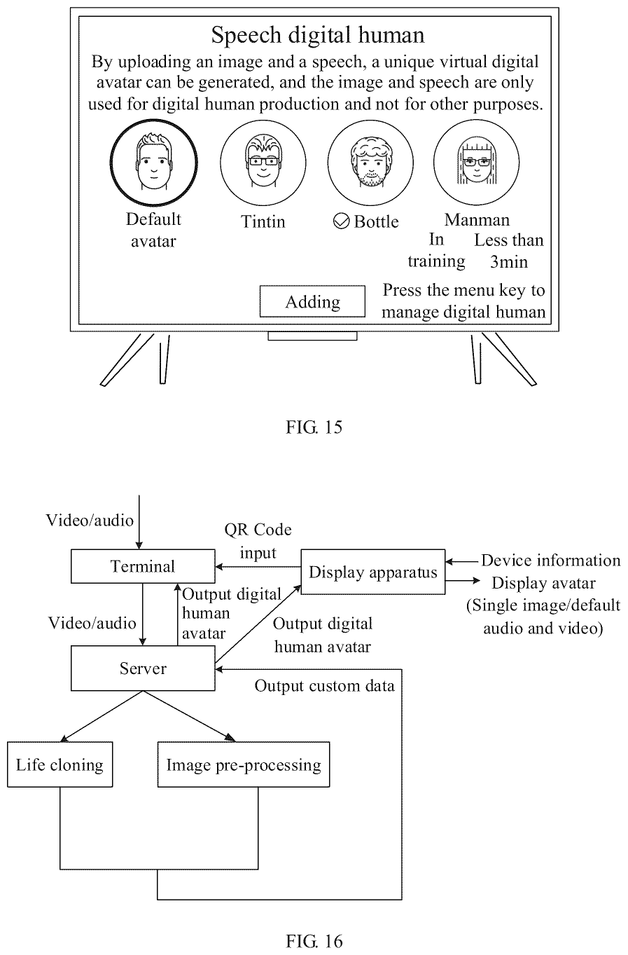

In some embodiments, after receiving the digital human name uploaded from the terminal 300, the server 400 sends an initial avatar and the digital human name to the display apparatus 200 and displays on the digital human selection interface. The digital human is identified as “in training” and may also identify a training time. In some embodiments, the digital human selection interface is shown in FIG. 15. After the training is completed, the server 400 sends the final avatar obtained by the training to the display apparatus 200 to update the display.

In some embodiments, a target speech (e.g., a greeting) generated based on a speech feature of the digital human may also be sent to the display apparatus 200, to play the speech corresponding to the timbre of the digital human when receiving that the user moves the focus to the control corresponding to the digital human. For example, in FIG. 8, when the focus 75 is received to move to the Tintin control 72, a speech of “Hello, I am Tintin” with a Tintin timbre is played.

In some embodiments, a target speech is generated based on a speech feature of the digital human, a key point sequence is determined based on the target speech. The image data is synthesized based on the key point sequence and the digital human avatar data. The image data and the target speech are sent to the display apparatus 200, and are saved locally by the display apparatus 200. The digital human control is displayed in a first frame (a first parameter) or a specified frame (specified parameter) in the image data, or drawn and displayed based on a first parameter or a specified parameter in the image data. The image and the target speech are played upon receiving that the user moves the focus to the digital human control.

In some embodiments, when displaying the digital human selection interface, the display apparatus 200 receives a command for managing the digital human input from a user.

The display 260 is controlled to display a digital human management interface in response to the command for managing the digital human input from the user. The digital human management interface may include a deletion control, a modification control, and a disabling control corresponding to at least one digital human.

If a command for selecting the deletion control input from the user is received, relevant data corresponding to the digital human is deleted.

If a command for selecting the disabling control input from the user is received, relevant data corresponding to the digital human is kept and annotated as disable.

If a command for selecting the modification control input from the user is received, the display 260 is controlled to display a modification identification code. After the terminal 300 scans the modification identification code, the video or photo of the user can be re-uploaded at the terminal 300 to change the avatar of the digital human, and/or, the audio of the user can be re-uploaded at the terminal 300 to change the speech feature of the digital human, and/or, the name/wake word of the digital human is changed at the terminal 300.

It should be noted that in the process of customizing the digital human, the user can quit the customization process at any time. The target application of the terminal 300 records the cache to the server in real time, and records the data of the user every time. When the user enters halfway, the target application obtains the previously recorded data from the server to provide convenience for the user to continue the operation, avoiding re-recording. If the user is not satisfied with continuing to record, the user can also choose to re-record at any time.

Embodiments of the present disclosure do not limit the order of the video recording, the audio recording, and the digital human naming.

In some embodiments, a schematic diagram of digital human interaction is shown in FIG. 16. A display apparatus 200 shows a QR Code. After scanning the QR Code, the terminal 300 receives the video and audio recorded by the user. The terminal 300 sends the recorded video and audio to the server 400. The server 400 obtains customization data of the digital human through the human speech clone technology and the image preprocessing technology. The customization data includes the digital human avatar and speech feature. The server 400 sends the digital human avatar to the terminal 300 and the display apparatus 200 respectively. The display apparatus 200 presents the digital human avatar on a user interface.

In some embodiments, the display apparatus 200 and the terminal 300 do not need to establish an association relationship. The adding digital human interface of FIG. 10 may also include a native uploading control 92. A command for selecting the local uploading control 92 input from a user is received. A camera of the display apparatus 200 is started, and image data of the user is captured by the camera. Or, the local video and image are displayed, and image data stored locally is selected by the user. The image data is uploaded to the server 400. The face point position detection and the digital human avatar data generation processing are performed by the server 400. The display apparatus 200 presents the digital human image based on the digital human avatar data sent from the server 400. Similarly, environment sound may also be collected by the sound collector of the display apparatus 200, and the display apparatus 200 sends the environment sound to the server 400. Ambient sound detection is performed by the server 400. The audio of the target text read by the user may also be sent through the sound collector of the display apparatus 200 or a speech collection function of the control device 100 to the server 400, and the digital human speech feature is generated by the server 400.

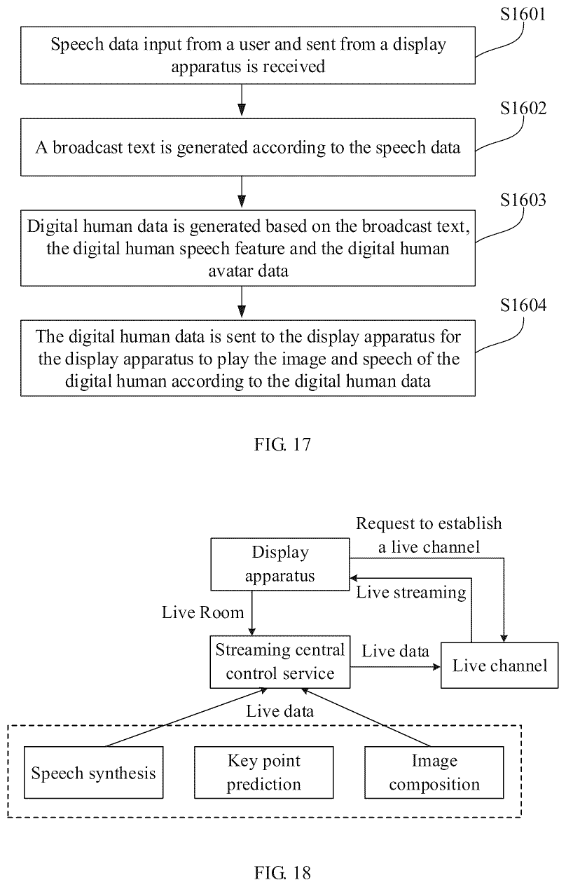

In some embodiments, embodiments of the present disclosure further improve some functions of the server 400. The server 400 performs following steps, as shown in FIG. 17.

Step S1601: Speech data input from a user and sent from a display apparatus 200 is received.

After starting the digital human interaction program, the display apparatus 200 receives the speech data input from the user.

In some embodiments, the step of starting the digital human interaction program may include: when the display apparatus 200 displays the user interface, receiving a command for selecting a control corresponding to a digital human application input from a user; where the user interface includes a control corresponding to an application installed on the display apparatus 200; in response to the command for selecting the control corresponding to the digital human application input from the user, displaying the digital human entrance interface as shown in FIG. 7.

In response to a command for selecting the natural conversation control 62 input from a user, the digital human interaction program is started, waiting for the user to input speech data through the control device 100 or control the sound collector to start collecting the speech data of the user. A natural conversation may include a small talk mode in which a user may chat with a digital human.

In some embodiments, the step of starting the digital human interaction program may include: receiving environment speech data collected by the sound collector; when it is detected that the environment speech data is greater than or equal to a preset volume or sound signal time interval of the environment speech data is greater than or equal to the preset threshold, determining whether the environment speech data includes a wake word corresponding to the digital human.

If the environment speech data includes a wake word corresponding to the digital human, a digital human interaction program is started, to control the sound collector to start collecting the speech data of the user and displaying a speech receiving box in a floating layer on the current user interface.

If the environment speech data does not include the wake word corresponding to the digital human, the related operation of displaying the speech receiving box is not performed.

In some embodiments, the digital human interaction program and the voice assistant may be installed in the display apparatus 200 at the same time. A command for setting a digital human interaction program as a default interaction program from a user is received, and the digital human interaction program is set as the default interaction program. The received speech data may be sent to the digital human interaction program, and the digital human interaction program sends the speech data to the server 400. It is also possible that the digital human interaction program receives the speech data and sends the speech data to the server 400.

In some embodiments, after the digital human interaction program is started, the speech data input from the user pressing the speech key of the control device 100 is received.

Collection of the speech data is started after the user starts to press the speech key of the control device 100. The collection of the speech data ends after the user stops pressing the speech key of the control device 100.

In some embodiments, after the digital human interaction program is started, when the speech receiving box is displayed in a floating layer on the current user interface, the sound collector is controlled to start collecting the speech data input from the user. If the speech data is not received for a long time, the digital human interaction program can be closed and the speech receiving box can be cancelled to be displayed.

In some embodiments, the display apparatus 200 receives speech data input from a user, and sends the speech data and a digital human identifier selected by the user to the server 400. The digital human identifier is used for representing an avatar, a speech feature and a name of the digital human.

In some embodiments, after the display apparatus 200 receives the speech data input from the user, the speech data and the device identifier of the display apparatus 200 are sent to the server 400. The server 400 obtains the digital human identifier corresponding to the device identifier from the database. It should be noted that when the display apparatus 200 detects that the user changes the digital human of the display apparatus 200, the changed digital human identifier is sent to the server 400, so that the server 400 changes the digital human identifier corresponding to the device identifier in the database to the modified digital human identifier. In embodiments of the present disclosure, the user does not need to upload the digital human identifier each time, and the digital human identifier can be directly obtained from the database.

In some embodiments, the user can select the digital human to be used through the digital human image displayed on the digital human selection interface as shown in FIG. 8.

In some embodiments, each created digital human has a unique digital human name, and the digital human name can be set as a wake word. The digital human selected by the user may be determined according to a wake word included in the environment speech data.

In some embodiments, the speech data input from the user and received by the display apparatus 200 is streaming audio data in nature. After receiving the speech data, the display apparatus 200 sends the speech data to a sound processing module, and acoustic processing is performed on the speech data by the sound processing module. Acoustic processing may include sound source localization, denoising, and sound quality enhancement. Sound source localization is used for enhancing or retaining the signal of the target speaker and suppressing the signals of other speakers in the case of a plurality of speakers, tracking the speakers and subsequent speech targeting pickup. Denoising is used for removing environmental noise and the like from the speech data. Sound enhancement is used for increasing an intensity of sound of a speaker when the sound is low. The purpose of the acoustic processing is to obtain a relatively clean and clear speech of the target speaker in the speech data. The speech data after the acoustic processing is sent to the server 400.

In some embodiments, after receiving the speech data input from the user, the display apparatus 200 directly sends the speech data to the server 400. The speech data is acoustically processed by the server 400 and the acoustically processed speech data is sent to a semantic service. After the server 400 performs speech recognition, semantic understanding and other processing on the received speech data, the processed speech data is sent to the display apparatus 200.

Step S1602: A broadcast text is generated according to the speech data.

After receiving the speech data, the semantic service of the server 400 recognizes the text content corresponding to the speech data by using the speech recognition technology. Processing such as semantic understanding, service distribution, vertical domain analysis, text generation and the like are performed on the text content to obtain a broadcast text.

Step S1603: Digital human data is generated based on the broadcast text, the digital human speech feature and the digital human avatar data.

In some embodiments, the semantic service of the server 400 may send the broadcast text or a semantic result to the display apparatus 200. The display apparatus 200 completes the speech interactive switching, and communicates with a streaming central control service of the server 400. That is, the display apparatus initiates a request to the streaming control service of the server 400, and the request carries the broadcast text or the semantic result. Speech synthesis, key point prediction, image synthesis and live interaction are completed by the streaming central control service.

In some embodiments, the semantic service of the server 400 may send the broadcast text directly to the streaming central control service. Speech synthesis, key point prediction, image synthesis and live interaction are completed by the streaming central control service.

In some embodiments, the digital human data may include digital human image data and a broadcast speech. The streaming central control service performing the step of generating digital human data based on the broadcast text, digital human speech feature and digital human avatar data may include: synthesizing the broadcast speech according to a speech feature and a broadcast text corresponding to a digital human identifier; where the broadcast text is input into a trained human speech clone model corresponding to the digital human identifier to obtain the broadcast speech with the timbre of the digital human. The broadcast speech is an audio frame sequence.

A key point sequence is determined according to the broadcast speech. Data preprocessing such as denoising and the like is performed on the broadcast speech to obtain a speech feature. The speech feature is input into an encoder to obtain a high-level semantic feature. The high-level semantic feature is input into a decoder. The decoder generates a predicted joint point sequence by combining a real joint point sequence to generate a body action of the digital human.

Digital human image data is synthesized according to the key point sequence and the digital human image data.

In some embodiments, a digital human image frame sequence is synthesized according to the key point sequence and the digital human avatar corresponding to the digital human identifier. Image synthesis is completed by using an image synthesis service according to the key point sequence predicted and digital human image data (digital human avatar), to obtain the digital human data, i.e. all image frame sequences and audio frame sequences.

In some embodiments, a digital human parameter sequence is generated according to the key point sequence and the digital human avatar data (digital human parameter). The digital human parameter sequence is parameter sequence of an avatar, a lip shape, an expression, an action and the like of the digital human. Digital human data is obtained according to the key point sequence predicted and the digital human avatar data (digital human parameter), i.e., all digital human parameter sequences and audio frame sequences.

Step S1604: The digital human data is sent to the display apparatus 200 for the display apparatus 200 to play the image and speech of the digital human according to the digital human data.

In some embodiments, the streaming central control service relies on a live broadcast channel to encode the image frame sequence and broadcast speech and then push the image frame sequence and broadcast speech encoded to the live broadcast room to complete the digital human streaming.

In some embodiments, the live data streaming process is shown in FIG. 18. The terminal 300 sends a request for establishing a live channel to the live channel, and creates a live channel room and sends the live channel room to the streaming central control service. The streaming central control service sends live broadcast data obtained through steps of speech synthesis, key point prediction, image synthesis, and the like in a live broadcast streaming mode to the display apparatus 200 through the live channel for the display apparatus 200 to play.

The streaming central control service is an important part of driving display and terminal presentation of digital human, and is responsible for driving and display of virtual avatars, to reflect the customization and driving effect of the whole digital human.

Following three types of requests from the display apparatus are received by the streaming central control service: 1) restart, the streaming central control service interrupts current video playback, re-applies for a room instance, verifies effectiveness and sensitivity of a customized avatar, records an instance state, creates a live broadcast room and releases the broadcast, to complete a live broadcast preparation action; 2) query, the streaming central control service processes the request content asynchronously, performs actions such as speech synthesis, key point prediction, image synthesis, live broadcast room streaming and the like until the image frame group and the audio frame group are pushed, completes the live broadcast, destroy the room, and recycle the instance; 3) stop, the streaming central control service interrupts the current video playback, destroys the room, and recycles the instance.

In order to ensure the real-time driving of digital human, the live broadcast technology is used, to perform digital human synthesis data on the received request content in real time and stream to the live broadcast room, so that the instant broadcast at the broadcast end is realized.

In addition, the streaming central control service uses the instance pooling mechanism. Only one instance for the same verification information is applied to be used. An instance pool automatically recycles an end-of-life instance for use by other devices. An instance that is abnormal or has not been recycled for a long time will be automatically found by the instance pool and destroyed to recreate a new instance, to guarantee the quantity of healthy instances of the instance pool.

A display apparatus 200 injects an encoded image frame sequence and broadcast speech received to a decoder for decoding, and synchronously plays the decoded image frame and the broadcast speech, i.e., the image and the speech of the digital human.

In some embodiments, the server 400 sends the digital human parameter sequence and the broadcast speech to the display apparatus 200. The display apparatus 200 draws and draws the digital human image based on the digital human parameter and the basic model. The drawn digital human image is synchronously displayed when playing the broadcast speech.

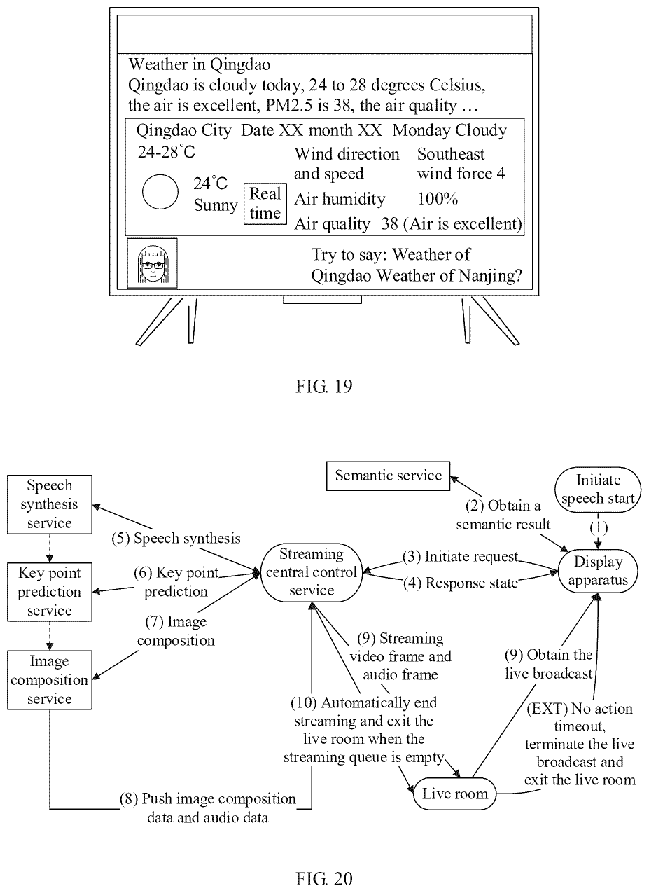

In some embodiments, after recognizing the speech data, in addition to the digital human data, the server 400 further sends request user interface data or media resource data in the speech data. The display apparatus 200 displays the user interface data sent from the server 400 and displays the digital human data at a specified position. In some embodiments, when the user inputs “What's the weather like today”, the user interface of the display apparatus 200 is as shown in FIG. 19.

In some embodiments, the digital human image is displayed at the user interface layer.

In some embodiments, the digital human image is displayed in a floating layer on the user interface layer.

In some embodiments, the user interface layer is located on top of a video layer. The digital human image is displayed in a preset region of the video layer. A target region is drawn on a user interface layer. The target region is in a transparent state. The preset region is coincident with a position of the target region so that the digital human image at the video layer can be displayed to the user.

In some embodiments, a digital human interaction sequence diagram is shown in FIG. 20. After receiving speech data, the display apparatus 200 sends the speech data to the semantic service. The semantic service sends a semantic result to the display apparatus 200. The display apparatus 200 initiates a request to the streaming central control service. After the streaming central control service responds, the streaming central control service generates image synthesis data through speech synthesis, key point prediction and image synthesis service, and pushes the image synthesis data and audio data to the live broadcast room. The display apparatus 200 may obtain the live broadcast data from the live broadcast room. When the pushing queue is empty, the streaming central control service automatically ends the streaming and exits the live broadcast room. The display apparatus 200 detects no action timeout, ends the live broadcast, and exits the live broadcast room.

Embodiments of the present disclosure supports the general digital human high-fidelity customization capability of providing small samples and low resource consumption for enterprise users and individual users, and also provides a new anthropomorphic intelligent interactive system based on reproduction of digital human avatar and sound. The digital human avatar may include a 2D real human avatar, a 2D cartoon avatar, a 3D real human avatar, and the like. The user enters the terminal customization process by scanning the code through the application, customizes an exclusive digital human avatar by collecting second-level video information/self-timer image information of the user, customizes exclusive sound by collecting 1 to 10 sentences of audio data of the user to realize customization of exclusive digital human sound. After the customization is completed, the avatar and the speech can be selected and switched through the display apparatus 200. Voice and text-based interaction is provided by selecting an avatar and a timbre. The display apparatus 200 receives the user request during the interaction. The reply (broadcast text) is generated by perceptual and cognitive algorithm services based on semantic understanding, speech analysis, empathy understanding, etc. The reply is output in the form of video and audio through the avatar and sound of the digital human. Audio and video data are generated by speech synthesis, face driving, image generation and other algorithm services, and are coordinated and forwarded to a target display apparatus by the streaming central control service, to complete one interaction.

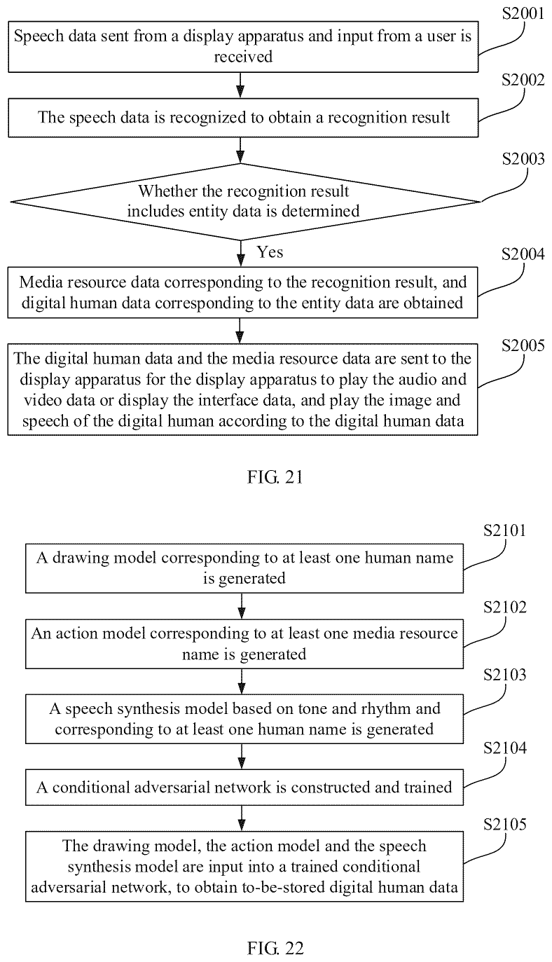

In some embodiments, embodiments of the present disclosure further improve some functions of the server 400. The server 400 performs following steps, as shown in FIG. 21.

Step S2001: Speech data sent from a display apparatus 200 and input from a user is received.

Step S2002: The speech data is recognized to obtain a recognition result.

After receiving the speech data input from the user and sent from the display apparatus 200, the server 400 recognizes a text corresponding to the speech data using the speech recognition technology.

Step S2003: Whether the recognition result includes entity data is determined, where the entity data may include a human name and/or a media resource name.

After obtaining the recognition result, the semantic service of the server 400 performs semantic understanding on the text content. In the process of semantic understanding, the recognized text is processed by word segmentation and annotation to obtain word segmentation information. Whether the word segmentation information includes entity data is determined.

If the recognition result does not include the entity data, semantic understanding, service distribution, vertical domain analysis, text generation and the like are performed on the recognition result to obtain a broadcast text. Digital human data is generated based on the broadcast text, the digital human speech feature and the digital human avatar, and the digital human data is sent to the display apparatus 200 so that the display apparatus 200 plays the digital human data.

If the recognition result includes the entity data, step S2004 is performed: obtaining media resource data corresponding to the recognition result, and digital human data corresponding to the entity data. The digital human data includes image data and broadcast speech of the digital human. The media resource data includes audio and video data or interface data. The audio and video data refer to at least one of audio data and video data.

If the recognition result includes the entity data, the server 400 positions a domain and intention through vertical domain classification based on the word segmentation information, and obtain media resource data corresponding to the domain and intention.

Before receiving the speech data input from the user and sent from the display apparatus 200, the server 400 performs preprocessing and standardization from three parts of a facial image, a body gesture, and speech, then performs model training to generate a highly realistic digital human avatar model.

FIG. 22 shows a flow of generating a digital human avatar model according to embodiments of the present disclosure. As shown in FIG. 22, the flow may include following steps.

Step S2101: A drawing model corresponding to at least one human name is generated.

The step of generating the drawing model corresponding to at least one human name may include: obtaining a preset quantity of images corresponding to the human name.

There is a large quantity of materials corresponding to the human name on the network. Photos and videos corresponding to the human name are collected based on a variety of different angles, and are set as an original data set for training. The images are preprocessed and annotated. Key features of the digital human are extracted, such as facial expression, posture and so on. The purpose of preprocessing is to remove watermarks and so on, to make the human in the photos or videos clearer. Annotation is to annotate the human in the photo.

The images are input into a text-to-image model to obtain the drawing model corresponding to the human name.

A LoRA model (a small drawing model) corresponding to the human name is generated based on clear angles and scenarios of collected different human photos (10 to 20 photos) using a text-to-image large model (Stable diffusion).

Step S2102: An action model corresponding to at least one media resource name is generated.

The step of generating the action model corresponding to at least one media resource name includes following steps.

A preset quantity of pieces of sample video data is obtained, and preprocessing and annotation are performed on the sample video data.

A plurality of groups of video data with different topics are obtained. Each group of video data includes a plurality of pieces of video data with the same topic. Preprocessing and standardization are performed on a plurality of pieces of video data with the same topic. The preprocessing on the video data includes video editing, denoising, and annotation. The standardization on the video data refers to adjustment of the motion amplitude of human in the video data to a unified standard. The purpose of preprocessing and standardization is to remove irrelevant information and unify standards for subsequent model training.

An action generation model is trained by using the sample video data annotated.

The video data after the preprocessing and standardization is used for annotating bone key points. A deep learning algorithm is used to train the action generation model to learn typical actions and action sequences in the video. In the training process, the model needs to be annotated iteratively for many times to optimize the action authenticity of the model.

The video data corresponding to the media resource name is input into the action generation model trained to generate the action model corresponding to the media resource name.

Step S2103: A speech synthesis model based on tone and rhythm and corresponding to at least one human name is generated.

In some embodiments, a preset quantity of pieces of sample audio data is obtained. The sample audio data may include audio data corresponding to a human name and audio data corresponding to a media resource name.

Preprocessing and annotation are performed on the sample audio data.

The preprocessing on the audio data corresponding to the human name is to denoise and annotate the human name.

The step of preprocessing the audio data corresponding to the media resource name may include following steps.
1) Audio processing: audio data is processed, such as separation of singing and accompaniment. Audio processing software such as Audacity can be used for processing.
2) Song analysis: the singing is analyzed by using audio processing software or music analysis tools, such as Sonic Visualizer, to extract tone and rhythm information of the singing.
3) Lyric conversion: a lyric conversion tool is used to convert the lyrics of the song into text format. An online lyric conversion tool, such as LRC (lyrics) file to text tool, is used to convert.

The audio data is a representative piece of audio data in the whole song. The audio data is annotated with the corresponding media resource name and the corresponding lyrics in the sample audio data.

A speech synthesis model is trained by using the sample audio data annotated, to obtain the speech synthesis model based on tone and rhythm corresponding to the human name.

A speech synthesis (Text To Speech, TTS) model is trained using a deep learning algorithm, to learn the tone and rhythm information of the song and the timbre of the human, and to convert the lyrics to speech. During the training process, the model needs to be iterated several times to continuously optimize the generation ability of the model. The trained TTS model is used to generate the speech based on the tone and rhythm and in accordance with the timbre of the human.

In some embodiments, a preset quantity of pieces of audio data corresponding to the human name is obtained. A speech synthesis model is trained based on the audio data of the human by utilizing a human speech clone technology. After the text data is input, the speech synthesis model may generate a speech corresponding to the text data in accordance with the timbre of the human.

Audio data of a preset quantity of songs is obtained, and preprocessing and annotation are performed on the audio data.

The speech synthesis model corresponding to the human is further trained by using the annotated audio data, to obtain the speech synthesis model based on tone and rhythm and corresponding to the human name.

In some embodiments, audio data of a preset quantity of songs is obtained and the audio data is pre-processed and annotated. The TTS model is trained by using the annotated audio data of the songs to obtain a speech synthesis model based on pitch and rhythm. After text data is input, the speech synthesis model can generate speech corresponding to the text data and have tone and rhythm corresponding to the text data.

A preset quantity of pieces of audio data corresponding to the human name is obtained. The speech synthesis model is further trained based on the tone and the rhythm by using the audio data corresponding to the human name, to obtain the speech synthesis model based on tone and rhythm and corresponding to the human name.

Step S2104: A conditional adversarial network is constructed and trained.

Step S2105: The drawing model, the action model and the speech synthesis model are input into a trained conditional adversarial network, to obtain to-be-stored digital human data.

Embodiments of the present disclosure use a conditional generative adversarial network (Conditional GAN), Variational Autoencoder, deep reinforcement learning and other technologies to generate an integrated model. The specific steps to integrate the model are as follows.
1) Construction of a conditional generative adversarial network: a conditional generative adversarial network is constructed, and the conditional generative adversarial network can include two modules of a generator and a discriminator. The generator receives the LoRA avatar model (drawing model) corresponding to the human name, the action model corresponding to the media resource name, and the TTS model as input, and generates a complete digital human avatar model. The discriminator receives the complete digital human avatar model and the real digital human avatar model as input, and performs determination on the complete digital human avatar model and the real digital human avatar model.
2) Model training: LoRA avatar models corresponding to a large quantity of human names, action models corresponding to media resource names and TTS models are used, to mainly annotate and adjust parameters of the action and sound, and train the conditional generative adversarial network. In the training process, parameters of the generator and the discriminator are continuously optimized, to realize the digital human avatar generation effect with high sense of reality and high fidelity.
3) Generation of a digital human avatar model: a complete digital human avatar model is generated by using the trained condition generative adversarial network. LoRA avatar models corresponding to different human names, action models corresponding to media resource names, and TTS models can be input, to obtain different digital human avatar model effects.
4) Optimizing and adjusting: optimizing and adjusting are performed on the digital human avatar model according to actual requirements of the digital human image, to improve the reality and fidelity of the digital human avatar. For example, the digital human avatar model may be optimized for facial expressions and body postures, to realize a more real and vivid digital human avatar effect.
5) Rendering and animation processing: rendering and animation processing are performed on the digital human avatar, to realize a more real and vivid digital human avatar effect. Nerf and other rendering algorithms are used to render the digital human, and animation software is used to animate the digital human.

In some embodiments, the storing step of the digital human avatar model may include: performing feature annotation on the to-be-stored digital human data and storing the to-be-stored digital human data after the feature annotation into the server 400; performing feature annotation on the to-be-stored digital human data, and performing cloud storage.

In some embodiments, the stored feature structure is as follows: [human name, media resource name, popularity degree]. The popularity degree is a quantity of pieces of training data, and the quantity of training data that can be found in the network is also a reflection of the popularity degree of humans and media resources.

In some embodiments, the stored feature structure is as follows: [human name (including basic attributes such as gender, age, etc.), media resource name, popularity degree].

In some embodiments, all the to-be-stored digital human data may be feature annotated and then stored into the server 400.

In some embodiments, part of the to-be-stored digital human data (the to-be-stored digital human data with a high popularity degree) may be feature annotated and then stored into the server 400.

The step of performing feature annotation on the to-be-stored digital human data and storing the digital human data to the server after the feature annotation may include: annotating human information, a media resource name and a popularity degree of the to-be-stored digital human data. The human information may include basic attributes such as a human name, gender, and age. Basic attributes such as gender and age facilitate filtering of requests from the user. For example, the user's request is to query videos of female singers between the ages of 20 and 40. If age data cannot be determined only from the name, then the basic attribute of the human can be further set.

A first popularity degree and a second popularity degree are obtained. The first popularity degree is the highest popularity degree corresponding to the human name in digital human data stored. The second popularity degree is the highest popularity degree corresponding to the media resource name in the digital human data stored.

Whether the popularity degree of the to-be-stored digital human data is less than a first popularity degree is determined.

If the popularity degree of the to-be-stored digital human data is not less than the first popularity degree, the to-be-stored digital human data annotated is stored into the server 400.

If the popularity degree of the to-be-stored digital human data is less than the first popularity degree, whether the popularity degree of the to-be-stored digital human data is less than a second popularity degree is determined.

If the popularity degree of the to-be-stored digital human data is not less than the second popularity degree, the to-be-stored digital human data annotated is stored into the server 400.

If the popularity degree of the to-be-stored digital human data is less than the second popularity degree, the to-be-stored digital human data annotated is not stored into the server 400.

In some embodiments, annotation information of the to-be-stored digital human data is that the human name is Little A, the name of the video is XX, and the popularity degree is 3000. If the highest popularity corresponding to Little A (human Little A-video YY) in the digital human data stored is 4000, and the highest popularity corresponding to XX (human small B-video XX) in the digital human data stored is 4000, the to-be-stored digital human data is not stored into the server 400. If the highest popularity corresponding to Little A (human Little A-video YY) in the digital human data stored is 2000 or the highest popularity corresponding to XX (the small B-video XX) in the digital human data stored is 2000, the to-be-stored digital human data is not required to be stored into the server 400.

In some embodiments, the digital human data stored in the server 400 may be updated periodically. Updating the digital human data stored may include periodically obtaining a large amount of new data to participate in the generation of the digital human data. Updating the digital human data stored may also include recording generation the time of the digital human data. If the current time exceeds the generation time for a certain period of time, the popularity degree corresponding to the digital human data can be appropriately reduced, to prevent humans or videos with high popularity in the early stage from occupying digital human data resources all the time, and it is impossible to push the recently updated and popular digital human data to users.

In some embodiments, if the recognition result includes the entity data, the step of obtaining the digital human data corresponding to the entity data may include: if the recognition result includes the human name, determining whether the digital human data stored includes the digital human data with the feature annotated as the human name.

If the digital human data stored does not include the digital human data with the feature annotated as the human name, processing such as semantic understanding, service distribution, vertical domain analysis, text generation and the like are performed on the recognition result to obtain a broadcast text. The digital human data is generated based on the broadcast text, the digital human speech feature selected and the digital human avatar, and the digital human data is sent to the display apparatus 200 so that the display apparatus 200 plays the digital human data.

If the digital human data stored includes the digital human data with the feature annotated as the human name, the stored digital human data with the feature annotated as the human name is obtained. The digital human data is video data with the avatar and the timbre of the human corresponding to the human name.

In some embodiments, speech data of “I want to watch the video of Little A” input from the user is received. After the speech data is recognized and segmented, it is determined that the recognition result includes the entity data of Little A. The server 400 obtains the digital human data corresponding to the Little A, and at the same time, obtains the media resource data corresponding to the Little A.

In some embodiments, when the human name corresponds to more than one piece of digital human data, the step of obtaining the digital human data corresponding to the human name method include: obtaining the digital human data with the feature annotated as the human name and with the highest popularity degree in the digital human data stored.

In some embodiments, speech data of “I want to watch the video of Little A” input from the user is received. After the speech data is recognized and segmented, it is determined that the recognition result includes the entity data of Little A. In the server 400, the highest popularity corresponding to Little A (human Little A-video YY) is 4000, and the highest popularity corresponding to video XX (human Little A-video XX) is 3000. Then the digital human data annotated as the Little A-video YY (the avatar and the timbre are of Little A, and the action and the lyrics are of video YY) is obtained. Meanwhile, the media resource data corresponding to the Little A is obtained.

In some embodiments, if the recognition result includes the entity data, the step of obtaining the digital human data corresponding to the entity data may include: if the recognition result includes a media resource name, determining whether the digital human data stored includes the digital human data with the feature annotated as the media resource name. If the digital human data stored does not include the digital human data with the feature annotated as the media resource name, digital human data is generated based on the broadcast text, the digital human speech feature selected, and the digital human avatar.

If the digital human data stored includes the digital human data with the feature annotated as the media resource name, digital human data with the feature annotated as the media resource name in the digital human data stored is obtained. The digital human data is the video data corresponding to the media resource name.

In some embodiments, speech data of “I want to watch XX video” input from the user is received. After the speech data is recognized and segmented, it is determined that the recognition result includes the entity data XX. The server 400 obtains the digital human data annotated as XX, and obtains the media resource data corresponding to XX.

In some embodiments, when the media resource name corresponds to more than one piece of digital human data, the step of obtaining the digital human data corresponding to the media resource name may include: obtaining the digital human data with the feature annotated as the media resource name and with the highest popularity degree in the digital human data stored.

In some embodiments, speech data in which the user inputs “I want to watch XX video” is received. After the speech data is recognized and segmented, it is determined that the recognition result includes the entity data XX. In the server 400, the highest popularity corresponding to Little A (human Little A-video YY) is 4000, and the highest popularity corresponding to video XX (human Little B-video XX) is 3000. Then the digital human data annotated as the Little B-video YY (the avatar and the timbre are of Little B, and the action and the lyrics are of video XX) is obtained. Meanwhile, the media resource data corresponding to the Little B is obtained.

In some embodiments, if the recognition result includes the entity data, the step of obtaining the digital human data corresponding to the entity data includes following steps.

If the recognition result includes the human name and the media resource name, whether the digital human data stored includes the digital human data with the feature annotated as the media resource name is determined.

If the digital human data stored does not include the digital human data with the feature annotated as the media resource name, digital human data is generated based on the broadcast text, the digital human speech feature selected, and the digital human avatar.

If the digital human data stored includes the digital human data with the feature annotated as the media resource name, whether the digital human data stored includes the digital human data with the feature annotated as the human name is determined.

If the digital human data stored does not include the digital human data with the feature annotated as the human name, digital human data with the feature annotated as the media resource name in the digital human data stored and an error message may be obtained. The digital human data may also be generated based on the broadcast text, the digital human speech feature selected, and the digital human avatar.

If the digital human data stored includes the digital human data with the feature annotated as the human name, whether the human name and the media resource name match feature annotations in the digital human data stored is determined.

If the human name and the media resource name match feature annotations in the digital human data stored, digital human data corresponding to the human name and the media resource name is obtained.

If the human name and the media resource name do not match feature annotations in the digital human data stored, a drawing model corresponding to the media resource name is replaced with a drawing model corresponding to the human name, and speech data corresponding to the media resource name is replaced with speech data corresponding to the human name, to generate digital human data replaced.

The digital human data replaced is determined as the digital human data corresponding to the human name and the media resource name.

In some embodiments, speech data of “I want to watch XX video of Little A” input from the user is received. After the speech data is recognized and segmented, it is determined that the recognition result includes two entity data of Little A and XX. In the server 400, the human corresponding to the video XX is annotated as a small B, that is, only the digital human data with human small B-video XX is stored. The LoRA avatar model of the video XX is replaced with the avatar of the Little A, the speech is replaced with the TTS model of the Little A, to generate digital human data replaced. Meanwhile, the media resource data corresponding to the XX video of Little A is obtained.

In some embodiments, the human name may be an individual name or a combination name. When the human name is a combination name, a plurality of human avatars may be reflected in one piece of digital human data.

Step S2005: The digital human data and the media resource data are sent to the display apparatus 200 for the display apparatus 200 to play the audio and video data or display the interface data, and play the image and speech of the digital human according to the digital human data.

In some embodiments, the digital human image data is an image frame sequence. The server 400 sends the image frame sequence and the broadcast speech to the display apparatus 200 through live streaming. The display apparatus 200 displays an image corresponding to the image frame and plays the broadcast speech.

In some embodiments, the digital human image data is a digital human parameter sequence. The server 400 sends the digital human parameter sequence and the broadcast speech to the display apparatus 200. The display apparatus 200 displays the image of the digital human and plays the broadcast speech based on the digital human parameter and the basic model.

If the media resource data is interface data, while presenting a user interface based on the interface data, the display apparatus 200 plays the image and speech of the digital human according to the digital human data.

If the media resource data is audio and video data, before playing the audio and video data before playing the audio and video data. The display apparatus 200 plays the image and speech of the digital human according to the digital human data.

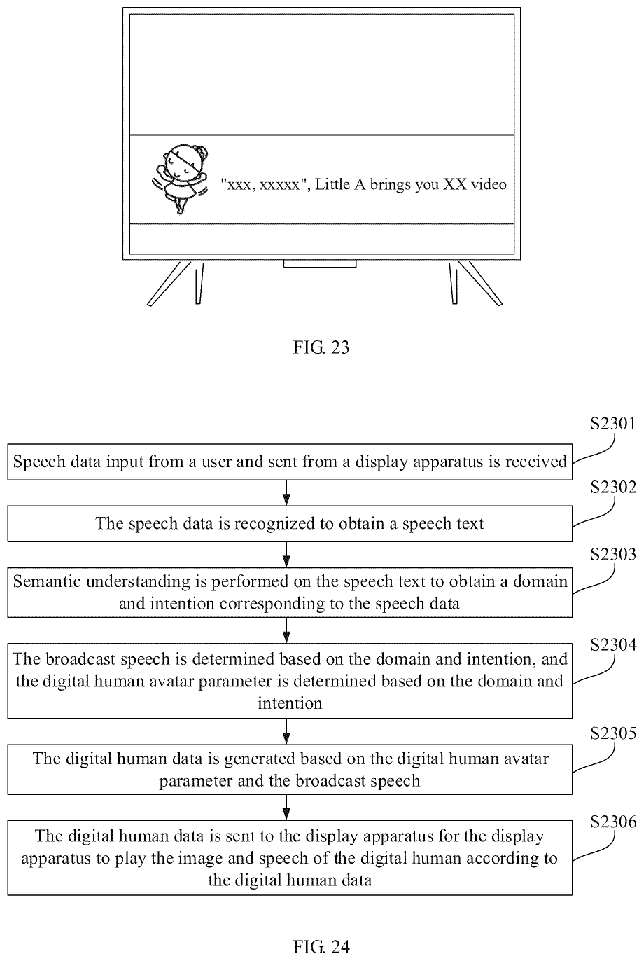

In some embodiments, the speech data of “I want to watch XX video of Little A” input from the user is received. The XX video data and the digital human data of the Little A are sent to the display apparatus 200. The display apparatus 200 may use the digital human avatar corresponding to Little A, the XX video action, and the singing of Little A to broadcast interestingly: “______” (singing), Little A brings you XX video, as shown in FIG. 23. After the broadcast is completed, XX video data is displayed.

In embodiments of the present disclosure, after photo and the video information of the stars or the network hot stalks at different angles are collected, a basic avatar and a specific action avatar of a human are generated, and then AIGC (Artificial Intelligence Generated Content, generative artificial intelligence) is used to generate and beautify the avatar of the human. A complete video avatar is generated based on each key point to drive the avatar action. A specific broadcast synthesis is added for personalized speech broadcast presentation. Three dimensions of the image, the action and the speech of the digital human are presented in a search scenario of the display apparatus 200, to increase the connection between search and speech feedback, and enhance the interest of speech interaction.

In some embodiments, embodiments of the present disclosure further improve some functions of the server 400. The server 400 performs following steps, as shown in FIG. 24.

Step S2301: Speech data input from a user and sent from a display apparatus 200 is received. Step S2302: The speech data is recognized to obtain a speech text.

After receiving the speech data input from the user and sent from the display apparatus 200, the server 400 recognizes a speech text corresponding to the speech data using a speech recognition technology.

Step S2303: Semantic understanding is performed on the speech text to obtain a domain and intention corresponding to the speech data.

The step of performing semantic understanding on the speech text to obtain the domain and intention corresponding to the speech data includes following steps.
1) Preprocessing is performed on the speech text. The preprocessing includes sensitive word filtering, text formatting and word segmentation and normalization.
2) A three-classification model service is invoked to determine a specific type of the speech text preprocessed, that is, to determined that the speech text preprocessed belongs to a chat type, a question-answer (questions & answers, qa) type, or a task type. There is no restriction on the three-classification algorithm.
3) If the specific type of the speech text preprocessed is determined to be the chat type, a chat service is invoked to analyze the chat intention, that is, to determine that the domain and intention corresponding to the speech data is chat.
4) If the specific type of the speech text preprocessed is determined to be the question-answer type, a question-answer service is invoked to determine whether a question-and-answer pair is hit.

If the question-and-answer pair is hit, it is determined that the domain and intention corresponding to the speech data is question and answer.

If the question-and-answer pair is not hit, the chat service is invoked to analyze the chat intention, that is, the domain and intention corresponding to the speech data is determined to be chat.
5) If it is determined that the specific type of the speech text preprocessed is determined to be the task type, the intention is continued to be analyzed, a strong rule algorithm is invoked and determine whether a strong rule is hit. The strong rule algorithms include regular matching and ABNF (augmented Backus-Naur Form) rule matching.

If the strong rule is hit, a corresponding domain, intention, and slot are returned.

If the strong rule is not hit, the reference is resolved; a multi-classification model service is invoked to obtain a corresponding domain, and a slot position and a grammar in the corresponding domain are analyzed, to match the corresponding intention, and output the domain, intention, and slot position.

Step S2304: The broadcast speech is determined based on the domain and intention, and the digital human avatar parameter is determined based on the domain and intention. The digital human avatar parameter is used for generating an image of the digital human and/or generating an action of the digital human.

The step of determining the broadcast speech based on the domain and intention includes following steps.

The broadcast text is determined based on the domain and intention. Different service systems are invoked according to the domain and intention to obtain a service result, i.e., the broadcast text.

The broadcast speech corresponding to the broadcast text is generated by using a speech synthesis technology. The broadcast speech is synthesized according to the speech feature corresponding to the digital human selected by the user and the broadcast text.

The step of determining the digital human avatar parameter based on the domain and intention includes following steps.

A digital human avatar mapping table is searched for a digital human avatar identifier corresponding to the domain and intention. The digital human avatar mapping table is used for representing a corresponding relationship between the domain and intention and the digital human avatar identifier.

In some embodiments, the digital human avatar mapping table is shown in Table 1.

TABLE 1

| | | Digital human |
|---|---|---|
| Domain | Intention | avatar identifier |
| Weather topic | Weather general search | 1 |
| Weather topic | Weather and | 2 |
| | temperature search | |
| Chat topic | Chat | 3 |
| Question and answer | Question and answer | 4 |
| topic | | |
| . . . | . . . | . . . |

A digital human definition table is searched for a digital human avatar parameter corresponding to the digital human avatar identifier. The digital human definition table is used for representing a corresponding relationship between the digital human avatar identifier and the digital human avatar parameter. The digital human avatar parameter includes a decoration parameter and an action parameter. The decoration parameter includes a digital human resource parameter, a clothing resource parameter, a hair resource parameter, a prop resource parameter, a makeup resource parameter and a special effect resource parameter, etc. The clothing resource parameter includes an upper clothing resource parameter, a lower clothing resource parameter, a shoe resource parameter and an accessory resource parameter. The action parameter includes an arm swing angle, a knee flexion angle, a facial expression parameter, etc.

In some embodiments, the digital human definition table is shown in Table 2.

TABLE 2

| Digital | | | | | |
|---|---|---|---|---|---|
| human | | Digital | Upper | Lower | |
| avatar | Avatar | human | clothing | clothing | Hair |
| identifier | name | resource | resource | resource | resource |
| 1 | Weatherman | Digital | Upper | Lower | Hair |
| | | human | clothing | clothing | resource |
| | | resource | resource | resource | identifier |
| | | identifier | identifier | identifier | |
| Digital | Shoe | Accessory | Action | Prop | |
| human | resource | resource | parameter | resource | |
| avatar | | | | | |
| identifier | | | | | |
| 1 | Shoe | Accessory | Action | Prop | |
| | resource | resource | identifier | resource | |
| | identifier | identifier | | identifier | |
| Digital | Avatar | Digital | Upper | Lower | Hair |
| human | name | human | clothing | clothing | resource |
| avatar | | resource | resource | resource | |
| identifier | | | | | |
| 2 | Chat | Digital | Upper | Lower | Hair |
| | | human | clothing | clothing | resource |
| | | resource | resource | resource | identifier |
| | | identifier | identifier | identifier | |
| Digital | Shoe | Accessory | Action | Prop | |
| human | resource | resource | parameter | resource | |
| avatar | | | | | |
| identifier | | | | | |
| 2 | Shoe | Accessory | Action | Prop | |
| | resource | resource | identifier | resource | |
| | identifier | identifier | | identifier | |
| Digital | Avatar | Digital | Upper | Lower | Hair |
| human | name | human | clothing | clothing | resource |
| avatar | | resource | resource | resource | |
| identifier | | | | | |
| 3 | Question | Digital | Upper | Lower | Hair |
| | and answer | human | clothing | clothing | resource |
| | | resource | resource | resource | identifier |
| | | identifier | identifier | identifier | |
| Digital | Shoe | Accessory | Action | Prop | |
| human | resource | resource | parameter | resource | |
| avatar | | | | | |
| identifier | | | | | |
| 3 | Shoe | Accessory | Action | Prop | |
| | resource | resource | identifier | resource | |
| | identifier | identifier | | identifier | |
| Digital | Avatar | Digital | Upper | Lower | Hair |
| human | name | human | clothing | clothing | resource |
| avatar | | resource | resource | resource | |
| identifier | | | | | |
| 4 | . . . | . . . | . . . | . . . | . . . |
| Digital | Shoe | Accessory | Action | Prop | |
| human | resource | resource | parameter | resource | |
| avatar | | | | | |
| identifier | | | | | |
| 4 | . . . | . . . | . . . | . . . | . . . |

Based on different clothing, hair, accessory, shoes and props, different digital human avatars can be formed.

Step S2305: The digital human data is generated based on the digital human avatar parameter and the broadcast speech.

In some embodiments, the digital human avatar may be determined by a digital human resource identifier in the digital human avatar parameter. The digital human resource identifier is used for identifying a basic model selected, or the basic model and a basic parameter. The basic parameter is used for representing feature offsets of facial key points, to realize customization of the digital human avatar.

In some embodiments, the digital human avatar may be determined by a digital human identifier uploaded by the display apparatus 200. The digital human identifier is a digital human identifier corresponding to a customized digital human selected by the user.

In some embodiments, the digital human model may be a digital human model of Unity. The digital human model of Unity is generally driven by the action parameter. The digital human model of Unity is mainly realized through an animation system of Unity, especially Animator Controller and Blend Trees. Animator Controller is the core of the animation system of Unity, allowing creating and managing animation states and transitions. The action parameter (such as speed, direction, whether to jump, etc.) can be defined in the Animator Controller. The playback of the animation is then controlled according to these parameters. Blend Trees is an important characteristic of Animator Controller, allowing different animations to be blended and transitioned based on the action parameter. For example, a Blend Tree is created to blend walking and running animations based on a speed parameter. In this way, a very complex and fluid animation can be created. For example, a digital human model can be created. When the speed parameter is changed, the model naturally transitions from walking to running.

In some embodiments, the step of generating the digital human data based on the digital human parameter and the broadcast speech includes following steps.

The digital human image parameter and broadcast speech are input into a digital human driving system to obtain digital human data. The digital human data includes a digital human decoration parameter, an action parameter, a lip shape parameter and a broadcast speech. When inputting into the digital human driving system, the lip shape parameter can be obtained through a digital human lip shape driving algorithm based on the broadcast speech. When inputting into the digital human driving system, the specific avatar parameter of the digital human can be obtained according to the decoration parameter of the digital human. Then the digital human data includes a final avatar parameter sequence, an action parameter sequence, a lip shape parameter sequence and a broadcast speech of the digital human.

The lip shape driving algorithm of the digital human is mainly used to synchronize a mouth shape of the human with the speech, so that mouth movement of the human matches with the pronunciation, increasing the sense of reality and vividness of the human.

In some embodiments, the lip shape driving algorithm is a rule-based method. The rule-based method is mainly based on characteristics of speech, such as phonemes, syllables and so on, to preset a set of mouth action rules. When the speech is input, the corresponding mouth shape action is generated according to the set of rules.

In some embodiments, the lip shape driving algorithm is based on a data-driven method. The data-driven method mainly uses a machine learning algorithm to learn a model from a large quantity of pieces of speech and mouth action data. This model is then used to predict the mouth movement of the new speech. The commonly used machine learning algorithm includes deep learning, support vector machine (SVM) and so on.

In some embodiments, the lip shape driving algorithm is a hybrid method. The hybrid method is a combination of the rule-based method and the data-driven method, utilizing both the clarity of rules and the flexibility of data-driven method.

In some embodiments, the step of generating the digital human data based on the digital human parameter and the broadcast speech includes following steps.

A key point sequence is predicted according to the broadcast speech.

A digital human image frame sequence is synthesized according to the key point sequence predicted, the digital human image selected by the user and the digital human avatar parameter.

The digital human data is digital human audio and video live broadcast data, i.e., digital human image frame sequence and broadcast speech.

Step S2306: The digital human data is sent to the display apparatus 200 for the display apparatus 200 to play the image and speech of the digital human according to the digital human data.

In some embodiments, when the digital human model of Unity is selected, the digital human decoration parameter (or the digital human final avatar parameter), the action parameter, the lip shape parameter and the broadcast speech are sent to the display apparatus 200. The display apparatus 200 may draw an avatar of the digital human model of Unity according to the digital human decoration parameter (or the digital human final image parameter), and drive the digital human model to make a corresponding action expression by using the action parameter and the lip shape parameter when the broadcast speech is played.

In some embodiments, the digital human data (the digital human image data and the broadcast speech) is sent to the display apparatus 200 through live streaming. The display apparatus 200 displays a digital human image based on the digital human image data and plays the broadcast speech.

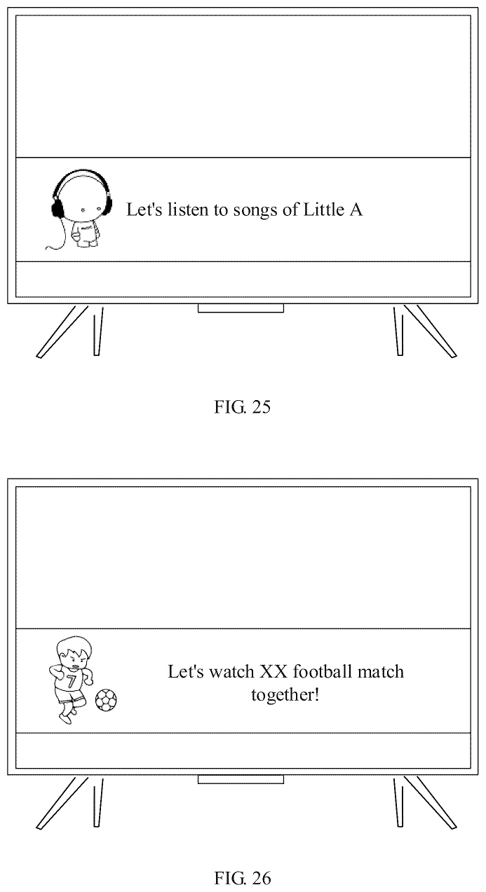

In some embodiments, when it is determined that the domain and intention is music, a prop with headphones may be configured on the digital avatar, as shown in FIG. 25. When it is determined that the domain and intention is football match, the clothing on the digital human avatar may be a ball uniform, the prop may be a football, and an action of kicking a ball is configured, as shown in FIG. 26.

In some embodiments, after receiving the speech data sent from the display apparatus 200 and input from the user or obtaining the speech text, the server 400 determines a user emotion type corresponding to the speech data. User emotion types are divided into three categories: Optimistic-optimistic (like-like, happy-happy, praise-praise and thankful-thankful), Pessimistic-pessimistic (angry-angry, disgusting-disgusting, fearful-fearful, sad-sad) and Neutral-neutral.

Emotion recognition technology is based on the analysis of human language, sound, facial expression, posture and other information, to recognize and understand human emotional states, and can help computer systems better understand and respond to human emotions, to achieve more intelligent and humane interactive experience.

In some embodiments, after receiving the speech data input from the user and sent from the display apparatus 200, the step of determining the user emotion type corresponding to the speech data includes following steps.

A user emotion type corresponding to the speech data is determined based on the speech data.

Embodiments of the present disclosure mainly analyze the tone, the audio characteristics, the speech content and the like in the speech data, to recognize the emotional state of the speaker. For example, by analyzing the characteristics of pitch, volume, speed, etc., in the speech data, whether the speaker is angry, happy, sad or neutral can be determined.

In some embodiments, after the speech text is obtained, the step of determining the user emotion type corresponding to the speech data includes following steps.

A user emotion type corresponding to the speech data is determined based on the speech text.

The present disclosure recognizes the emotional state of the user by analyzing information such as vocabulary, grammar, and semantics in the speech text. For example, by analyzing the emotion vocabulary, emotion intensity and emotion polarity in the speech text, whether the user is positive, negative or neutral can be determined.

In some embodiments, the step of determining the user emotion type corresponding to the speech data includes following steps.

When receiving the speech data input from the user and sent from the display apparatus 200, the display apparatus 200 also uploads a user video collected. The user video includes a user facial image.

After receiving the wake speech of the digital human, the display apparatus 200 turns on the image collector of the display apparatus 200, and collects that video data of the user while receiving the speech data input from the user. After the user video data is sent to the server 400, if the server 400 detects a facial image in the user video, a step of analyzing the facial image of the user is performed. If no facial image is detected in the user video, the user emotion type may be determined to be neutral.

The user facial image is analyzed to determine the user emotion type corresponding to the speech data.

Embodiments of the present disclosure recognize the emotional state of a human by analyzing facial expression features in a facial image or video. For example, by analyzing movements and changes of eyes, eyebrows, mouth and other parts in facial expressions, whether the emotional state of the human is angry, happy, sad or surprised can be determined.

In some embodiments, the step of determining the user emotion type corresponding to the speech data includes following steps.

When receiving the speech data input from the user and sent from the display apparatus 200, the server also receives a user physiological signal uploaded and collected by the display apparatus. The user physiological signal includes a heart rate, a skin conductance packet and/or a brain wave.

In some embodiments, after receiving the wake speech of the digital human, the display apparatus 200 turns on an infrared camera of the display apparatus 200, and collects a body temperature of the user while receiving the speech data input from the user.

In some embodiments, while receiving the speech data input from the user, the display apparatus 200 obtains information such as a heart rate collected by a smart device such as a bracelet associated with the display apparatus 200. A distance between the smart device and the display apparatus 200 needs to be within a certain range. If the server 400 does not receive the user physiological signal uploaded from the display apparatus, the user emotion type may be determined to be neutral.

A user emotion type corresponding to the speech data is determined based on the user physiological signal.

Embodiments of the present disclosure recognize the emotional state of the human by analyzing physiological signal of the human body, such as heart rate, skin conductance, brain wave, and the like. For example, by monitoring the change of heart rate, whether the human is nervous, relaxed or excited can be determined.

The step of determining the digital human avatar parameter based on the domain and intention includes following steps.

A digital human image parameter is determined based on the user emotion type and the domain and intention.

The step of determining the digital human avatar parameter based on the user emotion type and the domain and intention includes following steps.

A digital human avatar mapping table is searched for a digital human avatar identifier corresponding to the user emotion type and the domain and intention. The digital human avatar mapping table is used for representing a corresponding relationship between the domain and intention, the user emotion type and the digital human avatar identifier.

In some embodiments, the digital human avatar mapping table is shown in Table 3.

TABLE 3

| | | User | Digital human |
|---|---|---|---|
| | | emotion | avatar |
| Domain | Intention | type | identifier |
| Weather topic | Weather general search | Happy | 1 |
| Weather topic | Weather general search | Sad | 2 |
| Chat topic | Chat | Happy | 3 |
| Chat topic | Chat | Praise | 4 |
| Chat topic | Chat | Sad | 5 |
| . . . | . . . | . . . | . . . |

A digital human definition table is searched for a digital human avatar parameter corresponding to the digital human avatar identifier. The digital human definition table is used for representing a corresponding relation between the digital human image identifier and the digital human avatar parameter. The digital human avatar parameter includes a decoration parameter and an action parameter.

In some embodiments, the digital human definition table is shown in Table 4.

TABLE 4

| Digital | | | | | |
|---|---|---|---|---|---|
| human | | Digital | Upper | Lower | |
| avatar | Avatar | human | clothing | clothing | Hair |
| identifier | Name | resource | resource | resource | resource |
| 1 | Weather- | Digital | Upper | Lower | Hair |
| | man- | human | clothing | clothing | resource |
| | pleasant | resource | resource | resource | identifier |
| | avatar | identifier | identifier | identifier | |
| Digital | Shoe | Accessory | Action | Prop | |
| human | resource | resource | parameter | resource | |
| avatar | | | | | |
| identifier | | | | | |
| 1 | Shoe | Accessory | Action | Prop | |
| | resource | resource | | | |
| | identifier | identifier | identifier | resource | |
| | | | | identifier | |
| Digital | Avatar | Digital | Upper | Lower | Hair |
| human | Name | human | clothing | clothing | resource |
| avatar | | resource | resource | resource | |
| identifier | | | | | |
| 2 | Weather- | Digital | Upper | Lower | Hair |
| | man- | human | clothing | clothing | resource |
| | empathetic | resource | resource | resource | identifier |
| | avatar | identifier | identifier | identifier | |
| Digital | Shoe | Accessory | Action | Prop | |
| human | resource | resource | parameter | resource | |
| avatar | | | | | |
| identifier | | | | | |
| 2 | Shoe | Accessory | Action | Prop | |
| | resource | resource | identifier | resource | |
| | identifier | identifier | | identifier | |
| Digital | Avatar | Digital | Upper | Lower | Hair |
| human | Name | human | clothing | clothing | resource |
| avatar | | resource | resource | resource | |
| identifier | | | | | |
| 3 | Chat- | Digital | Upper | Lower | Hair |
| | pleasant | human | clothing | clothing | resource |
| | avatar | resource | resource | resource | identifier |
| | | identifier | identifier | identifier | |
| Digital | Shoe | Accessory | Action | Prop | |
| human | resource | resource | parameter | resource | |
| avatar | | | | | |
| identifier | | | | | |
| 3 | Shoe | Accessory | Action | Prop | |
| | resource | resource | identifier | resource | |
| | identifier | identifier | | identifier | |
| Digital | Avatar | Digital | Upper | Lower | Hair |
| human | Name | human | clothing | clothing | resource |
| avatar | | resource | resource | resource | |
| identifier | | | | | |
| 4 | . . . | . . . | . . . | . . . | . . . |
| Digital | Shoe | Accessory | Action | Prop | |
| human | resource | resource | parameter | resource | |
| avatar | | | | | |
| identifier | | | | | |
| 4 | . . . | . . . | . . . | . . . | . . . |

In the same domain and intention, digital human avatars aiming at different users and different emotions can be formed according to the change of the color matching based on the clothes.

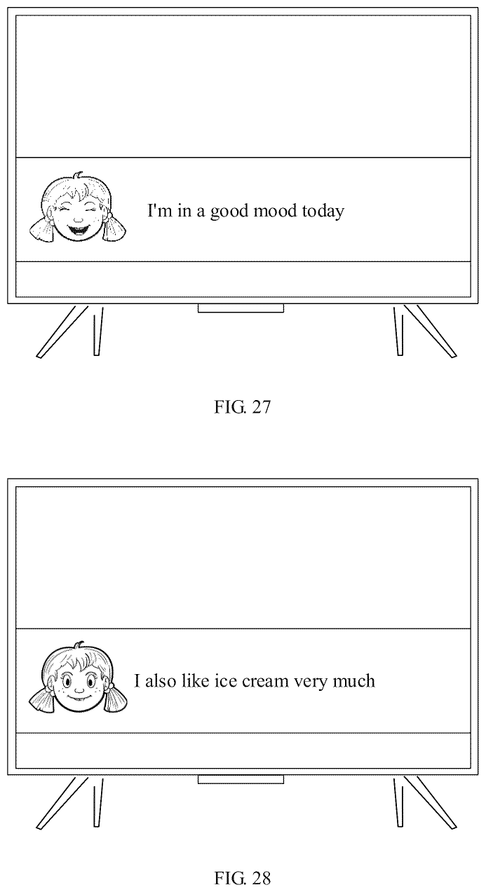

In some embodiments, the user emotion type in the chat mode is pleasant, and then a pleasant digital human avatar is used, as shown in FIG. 27. If the user emotion type is favorite, then a favorite avatar is used, as shown in FIG. 28.

In some embodiments, when the domain and intention is a weather search, if it is recognized that the user emotion type is pleasant, the display apparatus 200 shows a digital human wearing a weatherman suit in a bright color (e.g., red, yellow). If it is recognized that the user emotion type is sad, the display apparatus 200 shows a digital human wearing a weatherman suit in a dark color (e.g., dark blue, gray).

In some embodiments, the server 400 may also perform: receiving speech data input from a user and sent from a display apparatus; recognizing speech data to obtain a speech text; determining a user emotion type corresponding to the speech data; performing semantic understanding on the speech text to obtain a domain and intention corresponding to the speech data; determining a broadcast speech based on the domain and intention, and determining a digital human avatar parameter based on the user emotion type; generating digital human data based on the digital human avatar parameter and the broadcast speech; and sending the digital human data to the display apparatus for the display apparatus to play the digital human data.

Embodiments of the present disclosure can adapt to the current scenario (the domain and intention) of the display apparatus by changing the clothes, props, and body actions of the digital human, to enhance interesting interactive experience and emotional resonance. At the same time, the clothing color, the expression and the body action of the digital human are timely changed according to the emotional tendency of the user to set off the atmosphere, having a soothing effect on bad moods.

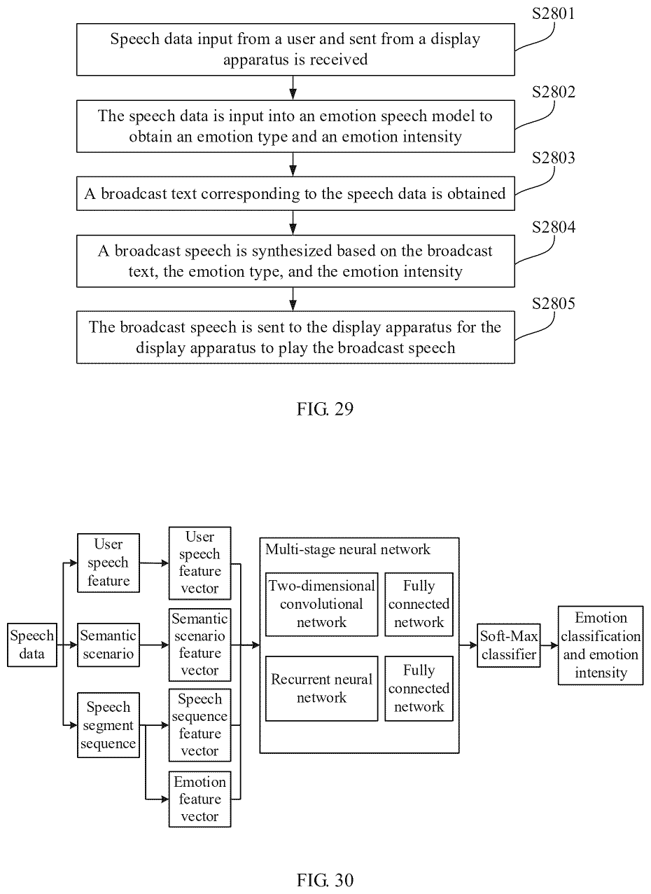

In some embodiments, embodiments of the present disclosure further improve some functions of the server 400. The server 400 performs following steps, as shown in FIG. 29.

Step S2801: Speech data input from a user and sent from a display apparatus 200 is received.

Step S2802: The speech data is input into an emotion speech model to obtain an emotion type and an emotion intensity.

The emotion speech model is obtained by training based on sample speech data of different groups of humans aiming at a plurality of semantic scenarios.

Sample speech data of groups of humans with different ages, genders, speech speeds, timbres, dialects and other dimensions for a plurality of semantic scenarios is collected, and the sample speech data is correspondingly annotated. The sample speech data is input into the emotion speech model for training, to adjust relevant parameters of the model. With the abundance of the sample speech data for training, the stable and accurate emotion type and emotion intensity can be obtained.

In some embodiments, as shown in FIG. 30, after the speech data is input to the emotion speech model, a speech feature, a semantic scenario and a speech segment sequence of the user are obtained. Then a user speech feature vector, a semantic scenario feature vector, a speech sequence feature vector and an emotion feature vector are determined. Next, feature processing is performed by a multi-stage neural network, and the Soft-Max classifier is used for feature classification. The emotion classification and emotion intensity of the speech data are obtained.

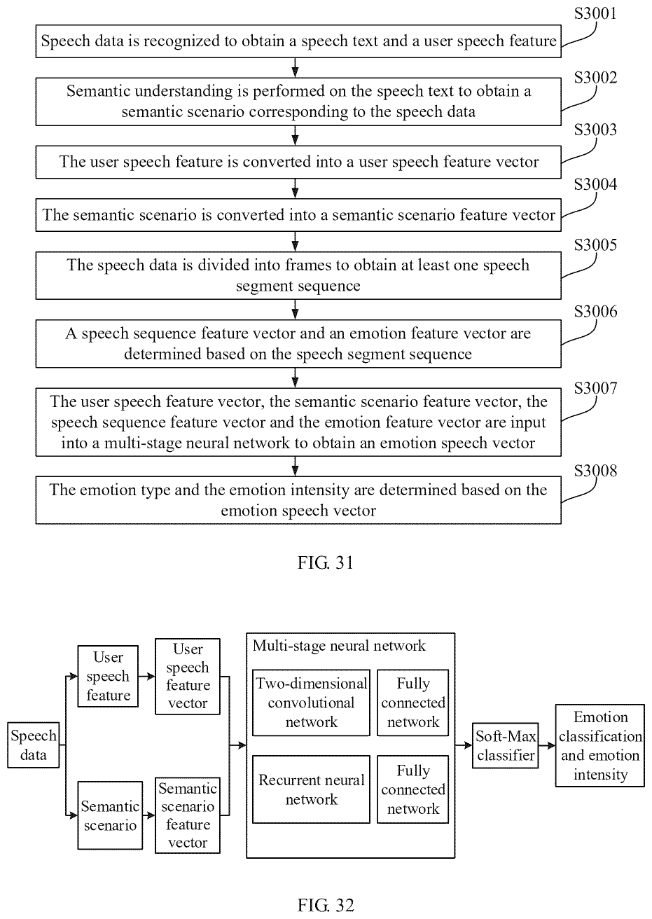

FIG. 31 shows the specific process of inputting the speech data into the emotion speech model to obtain the emotion type and the emotion intensity in step S2802. As shown in FIG. 31, following steps are included.

Step S3001: Speech data is recognized to obtain a speech text and a user speech feature. Speech recognition service using speech recognition technology (Automatic Speech

Recognition, ASR) is used to parse the speech text from the speech data. The speech text is the text content expressed by the user's speech.

Voiceprint recognition technology is used to analyze voiceprint, rhythm, intensity and trait of speech data to determine a user speech feature. The user speech feature includes age, gender, speech speed, timbre and dialect. The age can be child, adult and the elderly. The speech speed can be fast, medium and slow. The dialect can be Minnan dialect, Beijing dialect and Northeastern dialect.

Step S3002: Semantic understanding is performed on the speech text to obtain a semantic scenario corresponding to the speech data.

The step of performing semantic understanding on the speech text to obtain the semantic scenario corresponding to the speech data includes following steps.

Word segmentation and annotation processing are performed on the speech text to obtain word segmentation information.

In some embodiments, the speech text is “Andy Lau's Song”, and word segmentation and annotation processing are performed on the “Andy Lau's Song”, to obtain word segmentation information of [{Andy Lau-Andy Lau [actor—1.0, singer—0.8, roleFeeble—1.0, officialAccount—1.0]}, {‘s-’s [funcwordStructuralParticle—1.0]}, {song-song [musicKey—1.0]}].

Syntactic analysis and semantic analysis are performed on the word segmentation information to obtain slot position information.

In some embodiments, syntactic analysis and semantic analysis are performed on the word segmentation information to obtain that the central word is “song”, the modifier is “Andy Lau”, and the relationship is an adjective modifying relationship. In the semantic analysis, it is known that there is a strong semantic relationship between the song musicKey and singer. Therefore, a result of parsing the semantic slot position is: fused word segmentation information: [{Andy Lau-Andy Lau [singer—1.0]}, {song-song [musicKey—1.0]}].

A semantic scenario corresponding to the slot position information is positioned through vertical domain classification. The semantic scenario can be technically referred to as a domain and intention.

A central control system obtains the optimal vertical domain service by combining various service scores and allocates the optimal vertical domain service to the specific vertical domain service.

In some embodiments, a music domain and a music search intention are positioned through vertical domain classification. A central control intention set only contains MUSIC_TOPIC (music topic), and the obtained score is 0.9999393, score: {topicSet=[MUSIC_TOPIC], ‘Query’: [‘Andy Lau's Song’], ‘task’: 0.9999393}. Therefore, the optimal service is music service.

Step S3003: The user speech feature is converted into a user speech feature vector.

A group feature is converted into a feature vector representation, and is denoted as a user feature vector.

Step S3004: The semantic scenario is converted into a semantic scenario feature vector.

The semantic scenario is represented by a feature vector, and is denoted as a semantic scenario feature vector.

Step S3005: The speech data is divided into frames to obtain at least one speech segment sequence.

Step S3006: A speech sequence feature vector and an emotion feature vector are determined based on the speech segment sequence.

In some embodiments, the step of determining the speech sequence feature vector and the emotion feature vector based on the speech segment sequence includes following steps.

Feature extraction is performed on the speech segment sequence to obtain the speech sequence feature vector.

The emotion feature vector corresponding to the speech segment sequences is obtained based on a Mel spectrum feature extraction technology.

In some embodiments, text emotion analysis technology is used to analyze the input speech text to determine an emotional state desired to be expressed. The text emotion analysis technology can recognize emotion vocabulary, emotion intensity and emotion tendency through natural language processing and an emotion recognition algorithm.

Step S3007: The user speech feature vector, the semantic scenario feature vector, the speech sequence feature vector and the emotion feature vector are input into a multi-stage neural network to obtain an emotion speech vector.

The multi-stage neural network includes a two-dimensional convolutional network, a recurrent neural network and two fully connected networks. Parameters of the multi-stage neural network have been determined after training.

Convolutional neural network is a kind of feed-forward neural network which contains convolutional computation and has a deep structure, and is one of the representative algorithms of deep learning. The convolutional neural network has the ability of representation learning, and can perform translation-invariant classification on input information according to a hierarchical structure thereof.

Recurrent neural network (RNN) is a kind of recurrent neural network that takes sequence data as input, and recurses in an evolution direction of the sequence and in which all nodes (recurrent units) are connected in a chain.

Fully connected neural network is the most basic artificial neural network structure, also known as multilayer perceptron. In a fully connected neural network, each neuron is connected to all neurons in the previous and next layers, forming a dense connection structure. Fully connected neural network can learn complex characteristics of input data and perform tasks such as classification and regression.

Step S3008: The emotion type and the emotion intensity are determined based on the emotion speech vector.

The emotion speech vector obtains an emotion classification and an emotion intensity through a soft-max (normalized exponential function) classifier.

Embodiments of the present disclosure combines the semantic scenario, the gender and age characteristics of the user and the emotion feature of the speech of the user, to comprehensively output emotional intervention on speech synthesis, so that the process of speech interaction is more natural, improving the personality characteristics of voice assistants, and improving the user's speech interaction experience.

In some embodiments, by inputting speech data into the emotion speech model to obtain the emotion type and the emotion intensity, the influence of the emotion of the speech data input from the user on the broadcast speech emotion may not be considered. For example, as shown in FIG. 32, after the speech data is input to the emotion speech model, the user speech feature and the semantic scenario are obtained. Then a user speech feature vector and a semantic scenario feature vector are determined. Next, feature processing is performed by a multi-stage neural network, and the Soft-Max classifier is used for feature classification. The emotion classification and emotion intensity of the speech data are obtained.

In the above process, the specific process of inputting the speech data into the emotion speech model trained to obtain the emotion type and the emotion intensity includes: recognizing the speech data to obtain a speech text and a user speech feature; performing semantic understanding on the speech text to obtain a semantic scenario corresponding to the speech data; converting the user speech feature into a user speech feature vector and converting the semantic scenario into a semantic scenario feature vector; inputting the user speech feature vector and the semantic scenario feature vector into a multi-stage neural network to obtain an emotion speech vector; where the multi-stage neural network includes a two-dimensional convolutional network, a recurrent neural network and two fully connected networks; determining the emotion type and emotion intensity based on the emotion speech vector.

Step S2803: A broadcast text corresponding to the speech data is obtained.

In some embodiments, the step of obtaining the broadcast text corresponding to the speech data includes following steps.

Speech data is recognized to obtain a speech text.

Processing such as semantic understanding, service distribution, vertical domain analysis, text generation and the like is performed on the speech text to obtain a semantic service scenario and a broadcast text.

Semantic understanding is performed on the speech text to obtain slot position information and a semantic scenario corresponding to the speech data.

A service corresponding to the semantic scenario is invoked to determine a broadcast text corresponding to the slot position information.

The service corresponding to the semantic scenario analyzes the slot position, gives a service processing command result, combines a processing result, and synthesizes the broadcast text conforming to a semantic performing result.

In some embodiments, the music domain and the music search intent are positioned through domain classification, and the optimal service is determined to be the music service. Then a music micro service is used for processing. The music micro service may analyze the slot position Andy Lau, encapsulate music information, retrieve third-party music media information for search, and obtain a feedback result from the third party, such as information about 20 songs of Andy Lau. According to the music service scenario, a broadcast text “Find 20 songs such as forgiven love for you, come and listen!” is generated.

In some embodiments, the step of obtaining the broadcast text corresponding to the speech data includes following steps.

Slot position information and a semantic scenario corresponding to speech data are obtained from an emotion speech model.

A service corresponding to the semantic scenario is invoked to determine a broadcast text corresponding to the slot position information.

Step S2804: A broadcast speech is synthesized based on the broadcast text, the emotion type, and the emotion intensity.

In some embodiments, the step of synthesizing the broadcast speech based on the broadcast text, the emotion type, and the emotion intensity includes following steps.

A phoneme sequence corresponding to the broadcast text is determined.

Phoneme is the smallest phonetic unit divided according to natural attributes of speech, and is analyzed according to the pronunciation action in syllables. An action constitutes a phoneme.

An audio feature vector sequence corresponding to the phoneme sequence is generated.

An audio feature emotion is calculated based on the emotion type and the emotion intensity.

A broadcast speech with a tone, an intonation, and a volume corresponding to the emotion type and the emotion intensity is generated based on the audio feature vector sequence and the audio feature emotion.

Embodiments of the present disclosure utilize a speech synthesis technology to generate broadcast speech. Speech synthesis technology is used to convert text into natural and fluent speech, can generate speech by synthesizing phonemes, words or sentences, and adjust the intonation, speech speed, volume and other features of the speech according to output of the emotion model, to convey a specific emotional state.

In some embodiments, the step of synthesizing the broadcast speech based on the broadcast text, the emotion type, and the emotion intensity includes following steps.

The emotion type and the emotion intensity are input into an emotion model to obtain an emotion speech feature.

The emotion model may generate a corresponding speech expression according to the emotion classification and the emotion intensity. The emotion model is a trained machine learning model that maps an emotion type and an emotion intensity to a corresponding speech feature.

Broadcast speech is generated based on the emotional speech feature and the broadcast text by using a speech synthesis technology.

Step S2805: The broadcast speech is sent to the display apparatus 200 for the display apparatus 200 to play the broadcast speech.

In some embodiments, the display apparatus 200 sends a speech interaction identifier along with the speech data input from the user. The speech interaction identifier is used for determining a speech program used by the display apparatus 200, and the speech program includes a voice assistant and a digital human.

If it is detected that the speech interaction identifier is a voice assistant, after the broadcast speech is generated, the broadcast speech is sent to the display apparatus 200 for the display apparatus 200 to play the broadcast speech. The broadcast text may also be sent to the display apparatus 200 together with the broadcast speech, and the broadcast text is displayed on a user interface of the display apparatus 200.

If it is detected that the speech interaction identifier is a digital human, after the broadcast speech is generated, the server 400 performs following steps.

A key point sequence is predicted according to the broadcast speech.

Digital human image data is synthesized according to the key point sequence and the digital human avatar data.

In some embodiments, the digital human avatar data is avatar data corresponding to the digital human selected by the user. The avatar selected by the user may be determined according to a received digital human identifier sent from the display apparatus 200.

In some embodiments, the digital human avatar data is an image or a digital human parameter after adjustment of a digital human avatar parameter on the basis of an avatar selected by the user or default avatar. The digital human image data is a digital human image frame sequence or a digital human parameter sequence. The digital human avatar parameter is determined based on the scenario and/or the user emotion type.

The digital human image data and the broadcast speech are sent to the display apparatus 200 for the display apparatus 200 display the digital human image based on the digital human image data and play the broadcast speech.

In some embodiments, upon receiving the speech data input from the display apparatus 200, the speech data is recognized, to obtain the speech text and the user speech feature. Semantic understanding is performed on the speech text to obtain a semantic scenario and a broadcast text. The user speech feature and the semantic scenario (speech data can also be added) are input into an emotion speech model, to obtain the emotion type and emotion intensity. A broadcast speech is synthesized based on the broadcast text, the emotion type and the emotion intensity, and the broadcast speech is sent to the display apparatus, for the display apparatus to play the broadcast speech. It should be noted that, the input of the emotion speech model of embodiments of the present disclosure during training is the user speech feature and the semantic scenarios (speech data can also be added), the output is the emotion type and the emotion intensity. The internal processing method of the model refers to the above, and will not be described here.

In some embodiments, upon receiving the speech data input from the display apparatus 200, the speech data is recognized, to obtain the speech text and the user speech feature. Semantic understanding is performed on the speech text to obtain a semantic scenario and a broadcast text. The user speech feature, semantic scenario and broadcast text (speech data can also be added) are input into an emotion speech model, and the broadcast speech is sent to the display apparatus to enable the display apparatus to play the broadcast speech. It should be noted that, the input of the emotion speech model of embodiments of the present disclosure during training is the user speech feature, semantic scenario, broadcast text (speech data can also be added) and the output is the broadcast speech. The internal processing method of the model refers to the above, and will not be described here.

Embodiments of the present disclosure performs emotion speech model training by combining the semantic scenario, user speech feature and other aspects, fully excavating the user interaction characteristics, improving naturalness of emotion speech synthesis, and improving the user experience and emotional communication effect, so that the user can interact more naturally with the display apparatus 200.

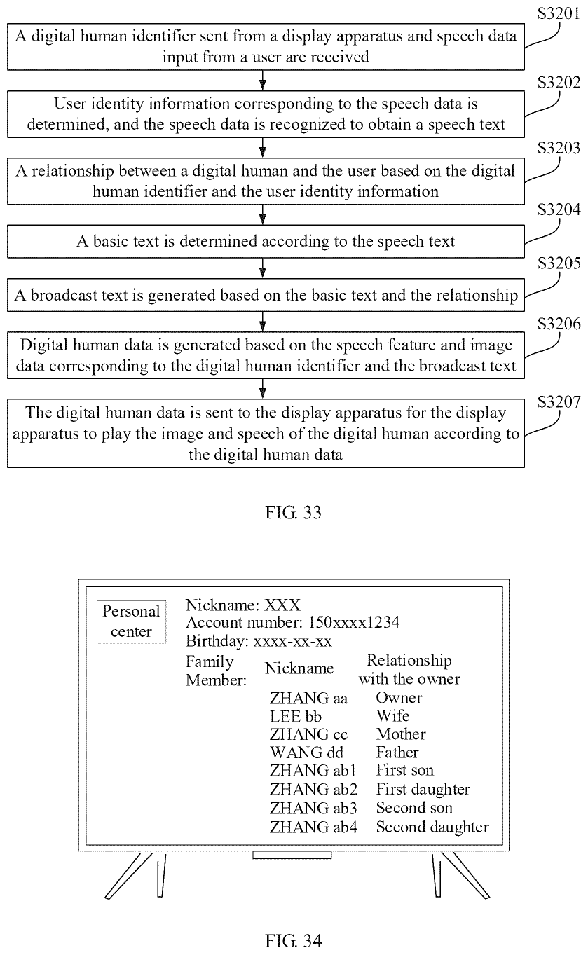

In some embodiments, embodiments of the present disclosure further improve some functions of the server 400. The server 400 performs following steps, as shown in FIG. 33.

Step S3201: A digital human identifier sent from a display apparatus 200 and speech data input from a user are received.

The digital human identifier is used for representing a digital human avatar and a speech feature selected by the user.

Before receiving the digital human identifier sent from the display apparatus 200 and the speech data input from the user, a digital human selection or customization (registration) process needs to be completed. A digital human required by the user can be selected from registered digital humans.

The digital human registration process includes following steps.
1) Avatar recording is as follows.

The user is supported to record videos, take photos or select album images for virtual human avatar generation. After receiving a video or photo record by a user, the server 400 generates a digital human avatar through a series of operations such as matting, beautifying, and image generation.
2) Timbre customization is as follow.

Timbre customization is to copy or reproduce the user's speech by using speech cloning technology based on audio recorded by the user after the user reads several basic texts. Timbre customization provides personalized playing timbres for digital human during speech interaction.
3) Setting a nickname (digital human naming) is as follows.

After the avatar recording and the timbre customization are completed, a nickname is created for a virtual digital human as digital human identifier. Under the same account, virtual digital human nicknames are not repeatable.

The above steps have been described in detail above and will not be repeated here.

It should be added that after the nickname is set, a step is also added: 4) setting members (for example, family members).

A member nickname corresponding to the user recording the digital human is selected to establish an association.

In some embodiments, a family member nickname may be filled in during setting a family member. A relationship between the family member and the owner is set, to construct a family relationship graph.

In some embodiments, a creation entrance for adding a family member is provided on the display apparatus, freely entered by the user. Family member information includes: a family member nickname (in order to protect the user's privacy, the real name may not be used), a relationship with the owner (used to construct a family relationship), a serial number (identified as birth ranking of a child, used to build a relationship between children).

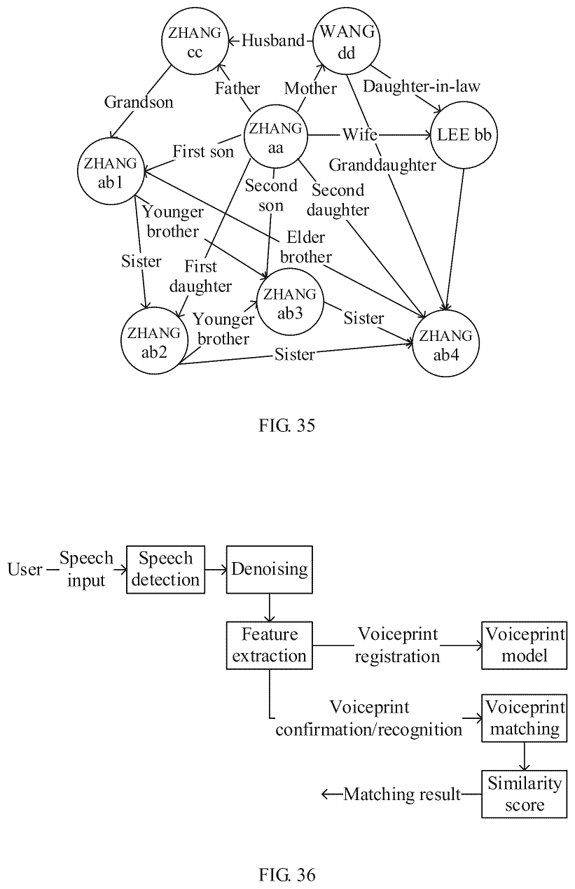

In some embodiments, after the family member is created, family member information can be viewed in the user's personal center, as shown in FIG. 34. A family relationship graph may be constructed based on the family member information, as shown in FIG. 35. Embodiments of the present disclosure have been drawn with a single line relationship for clarity of illustration, and should in fact be drawn with a double line relationship.

After the family member information is determined, in the process of setting the family member, a relationship between the user recording the digital human and the owner can be determined by filling in a family member nickname.

After a family member is set, a virtual digital human of the user is generated after an algorithm training process of 3 to 5 minutes, and can be selected as a digital human for speech interaction.

Digital human data storage is shown in Table 5.

TABLE 5

| | | Nicknames for |
|---|---|---|
| Digital human | Digital human | family |
| identifier | nickname | members |
| 1 | Jun | ZHANG aa |
| 2 | Aya | LEE bb |
| 3 | Lao ZHANG | ZHANG cc |
| . . . | . . . | . . . |

Step S3202: User identity information corresponding to the speech data is determined, and the speech data is recognized to obtain a speech text.

Voiceprint registration is required before determining the user identity information corresponding to the speech data.

In some embodiments, voiceprint registration may be perceptual registration, i.e., the user's voiceprint information is automatically recognized as the user speaks, to complete voiceprint registration. Voiceprint information of the speech data is extracted after receiving the speech data input from a user. If the voiceprint information does not match with registered voiceprint information in a personal voiceprint database, prompt information is popped up. The prompt information is used for prompting whether the user is registered as a new member. If a command for selecting not to register input from a user is received, a registration flow is not performed. If a command for selecting registration input from the user is received, the user is required to set a voiceprint nickname and a family member nickname, to establish an association relationship between a voiceprint account and a family member. In order to improve the accuracy of the voiceprint information, reading audio for basic text can also be supplemented.

Data storage of voiceprint information is shown in Table 6.

TABLE 6

| Voiceprint | Voiceprint | Nicknames for |
|---|---|---|
| identifier | nickname | family members |
| 1 | Brother | ZHANG aa |
| | Beard | |
| 2 | Fairy | LEE bb |
| 3 | Lao ZHANG | ZHANG cc |
| . . . | . . . | . . . |

In some embodiments, the voiceprint registration may be a guided registration. A voiceprint registration function can be found in a speech zone, which generally guides the user to complete the reading of three basic texts, sets a voiceprint nickname and a family member nickname, and completes voiceprint registration, so that an association relationship between the voiceprint account and the family member is established.

According to embodiments of the disclosure, identity verification or identification is performed by analyzing and comparing a speech feature of an individual through a voiceprint recognition technology. As shown in FIG. 36, after a series of operations such as user input speech detection, preprocessing (denoising, etc.), feature extraction, voiceprint comparison, and result determination, an identity of the speaker is confirmed. If a similarity between the voiceprint of the current speaker and the registered voiceprint information is high (greater than a set threshold), the speaker is considered to be the same human. The extracted voiceprint feature can be used for voiceprint registration to obtain a voiceprint model, and the voiceprint model is stored in a voiceprint database, for subsequent voiceprint comparison.

The step of determining the user identity information corresponding to the speech data includes following steps.

Voiceprint information of the speech data is extracted.

In some embodiments, the step of extracting voiceprint information of the speech data includes following steps.

Dividing the speech data into at least one piece of audio data with a preset length.

Pre-emphasis, framing and windowing is performed on a sound signal time course of the audio data to obtain the sound signal time course after windowing.

Fast Fourier transformation is performed on the sound signal time course after windowing to obtain frequency spectrum distribution information.

An energy spectrum is determined based on the frequency spectrum distribution information.

An energy spectrum is passed through a group of triangular filter banks to obtain logarithmic energy output from a filter.

The logarithmic energy is subjected to a discrete chord transformation, to obtain a Mel frequency cepstrum coefficient, a derivative and a second-order derivative corresponding to the Mel frequency cepstrum coefficient.

The Mel frequency cepstrum coefficient, and the derivative and the second-order derivative corresponding to the Mel frequency cepstrum coefficient are determined as voiceprint information.

Whether the voiceprint information matches with the registered voiceprint information in the voiceprint database is determined.

In some embodiments, the step of determining whether the voiceprint information matches the registered voiceprint information in the voiceprint database includes following steps.

A similarity between voiceprint feature information and the registered voiceprint information is determined.

A maximum quantity of similarities greater than a similarity threshold is counted.

If the maximum quantity is greater than the preset quantity, it is determined that the voiceprint information matches with the registered voiceprint information in the voiceprint database.

If the maximum quantity is not greater than the preset quantity, it is determined that the voiceprint information does not match with the registered voiceprint information in the voiceprint library.

If the voiceprint information matches with the registered voiceprint information in the voiceprint library, user identity information is determined according to the registered voiceprint information. That is, a voiceprint nickname and a family member nickname of the registered voiceprint information are obtained.

A speech recognition technology is used to convert speech data into a speech text.

Step S3203: A relationship between a digital human and the user based on the digital human identifier and the user identity information.

The user identity information includes a family member nickname the speaker.

A family member nickname corresponding to the digital human identifier is obtained.

A relationship between the digital human and the user in a family relationship graph based on the family member nickname of the speaker and the family member nickname corresponding to the digital human identifier.

In some embodiments, the family member nickname of the speaker is Zhang cc, the family member nickname corresponding to the digital human identifier is Zhang aa, then it is determined that the relationship between the digital human and the user is a parent-child relationship.

It should be noted that both the user and the digital human need to have family member nicknames to determine the relationship between the digital human and the user.

Step S3204: A basic text is determined according to the speech text.

The speech text is subjected to Natural Language Processing (NLP) to determine the basic text. The basic text refers to the text normally fed back to the speech data. Natural language processing (NLP) is a technology that takes language as its object and uses computer technology to analyze, understand and process natural language. Natural language processing includes two parts of Natural Language Understanding (NLU and Natural Language Generation (NLG). Natural language understanding is used to understand the meaning of natural language text. Natural language generation is used to express a given intention, idea, or the like in natural language text.

The step of determining the basic text according to the speech text includes following steps.

Word segmentation and annotation processing is performed on the speech text to obtain word segmentation information.

Syntactic analysis and semantic analysis is performed on the word segmentation information to obtain slot position information.

A domain and intention corresponding to the slot position information is positioned through vertical domain classification.

The basic text is determined based on the domain and intention and the slot position information.

The step of determining the basic text based on the speech text has been described in detail above, and will not be repeated here.

It should be noted that each speech domain service has a default basic text. The default basic text can be generated in real time within the service, and can also be pre-configured (data in a broadcast language configuration). For example, “Today's weather”, the basic text sentence pattern is {area (area)} {date (date)} {condition (condition)}, {temperature (temperature)}, {winddir (wind direction)} {windlevel (wind level)}, such as, it is cloudy in Beijing today, 22 to 29 degrees Celsius, north wind in 3 to 4 levels. Data in the broadcast language configuration: “Find the weather information for you” can also be selected.

Step S3205: A broadcast text is generated based on the basic text and the relationship.

A broadcast text generation method includes pre-splicing, post-splicing, pre-splicing+post-splicing and replacing the default basic text.

In some embodiments, the step of generating the broadcast text based on the basic text and the relationship includes following steps.

Splicing information corresponding to the relationship is obtained. The splicing information includes a splicing position and splicing content, the splicing position includes pre-splicing, and the splicing content corresponding to the pre-splicing is an appellation set according to the relationship.

The appellation set according to the relationship may be randomly selected by the server or set by the user.

The appellation of the speaker can be set according to a kinship. For example, dad can be called father, diedie, daddy, babi, laodie, laodou, and adjectives expressing intimacy can also be set, such as dear, respectful, beloved, etc.

A broadcast text is generated based on the splicing information and the basic text.

The splicing content is spliced to the splicing position of the basic text to generate a broadcast text.

In some embodiments, when the speech input from the user is “What's the weather like today”, through semantic analysis on the domain and intention and the slot position, the basic text is “Beijing is cloudy today, 22 to 29 degrees Celsius, and north wind in 3 to 4 levels” is obtained. After determining that the relationship between the digital human and the user is a parent-child relationship, if the splicing information is pre-splicing (splicing position)-dad (splicing content), the broadcast text “Dad, Beijing is cloudy today, 22 to 29 degrees Celsius, and north wind in 3 to 4 levels” is generated.

In some embodiments, if special text content is included in the basic text, the basic text can be replaced with text for special text content. For example, when querying the weather, one of the weather conditions is required to be highlighted, such as weather warning and excessive temperature difference, the broadcast text required can be spliced according to the weather information, and then the basic text is replaced to generate the broadcast text.

In some embodiments, if special text content is included in the basic text, some texts related to reminding can be configured for the special text content and added after the basic text. Some relational words can be configured according to the weather conditions, and can be combined with the basic text through post-splicing.

In some embodiments, the splicing position further includes post-splicing, and the step of generating the broadcast text based on the basic text and the relationship includes following steps.

An age of the user is obtained.

In some embodiments, the step of obtaining the age of the user includes determining the age of the user using speech recognition technology.

In some embodiments, at the time of voiceprint registration, an option to add an age may be added. The age of the user can be directly obtained from the voiceprint registration information.

The splicing content corresponding to the post-splicing is determined based on the age and the basic text.

The basic text includes special text content, and some texts related to reminding are configured for the special text content. Different splicing contents are set for different ages.

In some embodiments, when the speech input from the user is “What's the weather like today”, the basic text obtained by semantic analysis on the domain and intention and the slot position includes stormy weather. The basic text can be replaced by “there is a blue rainstorm warning today, 6-8 levels wind”. When the age of the speaker is determined to be the elderly, the splicing content corresponding to the post-splicing is “don't go out if you have nothing to do”. The broadcast text generated is “There is a blue rainstorm warning today, 6-8 levels wind, don't go out if you have nothing to do”. When the age of the speaker is determined to be middle-aged, the splicing content corresponding to the post-splicing is “remember to do a good job of protection when you go out”. The broadcast text generated is “There is a blue rainstorm warning today, 6-8 levels wind, remember to do a good job of protection when you go out”. Appellation can be added to the final broadcast text according to the relationship, such as “Dad, there is a blue rainstorm warning today, 6-8 levels wind, don't go out if you have nothing to do”.

In some embodiments, the step of generating the broadcast text based on the basic text and the relationship includes following steps.

Whether a current date is a target date is detected. The target date is a festival and/or an anniversary. The festival includes Father's Day, Mother's Day, Children's Day, Valentine's Day, etc. Anniversary includes birthday and wedding anniversary, etc. The anniversary can be written and stored by the user.

If the current date is detected to be the target date, whether the target date is related to a relationship is determined.

In some embodiments, the current date is Father's Day, and if the digital human has a child-parent relationship with the user, then Father's Day is related to the child-parent relationship. If the relationship between the digital human and the user is grandfather-grandchild, Father's Day is not related to the grandfather-grandchild relationship.

If the target date is related to a relationship, the target text is determined based on the relationship. The target text includes a blessing text and/or a reminding text.

If the user is determined to be the blessed human according to the relationship and the target date, the target text is determined to be the blessing text.

If the user is determined to be the blessing human according to the relationship and the target date, the target text is determined to be the prompt text.

In some embodiments, the current date is Father's Day, and if the digital human has a child-parent relationship with the user, then the target text is determined to be the blessing text, the blessing text is “Dad, Happy Father's Day, wish you happy every year, every year as you wish”. If the relationship between the digital human and the user is a parent-child relationship, the target text is determined to be the prompt text, and the prompt text is “Today is Father's Day, remember to send blessings to Dad”.

In some embodiments, the step of generating the broadcast text based on the basic text and the relationship includes following steps.

Whether the current date is a target date is detected.

If the current date is detected to be the target date, whether the target date is related to the user is determined.

In some embodiments, the current date is Children's Day, if the user is a child, then the current date is related to the user. If the user is an adult, then the Children's Day is not related to the user.

If the target date is related to the user, the target text is generated.

In some embodiments, the broadcast text is “Happy Children's Day to Baby”.

In some embodiments, the step of generating the broadcast text based on the basic text and the relationship includes following steps.

Whether a target date is included in a preset range of dates is detected. The preset range of dates may be the current date and based on three days after the current date.

If the target date is included in the preset range of dates, whether the target date is related to the user or the relationship is determined.

If the target date is related to the user or the relationship, the target text is generated. If the target date is not the current day, the target text is the prompt text to prompt how many days are left for the target date.

In some embodiments, if the intention resulting from parsing the speech text is a festival or anniversary query intention, an access query interface is invoked to obtain a name of the festival or the anniversary. A corresponding target text is queried in the broadcast text configuration, and is then spliced with the appellation to generate a broadcast text.

In some embodiments, if the intention resulting from parsing the speech text is not a festival or anniversary query intention, a festival query identifier corresponding to the user is obtained.

If the festival query identifier is 1, an access query interface is invoked while obtaining the basic text corresponding to the intention. The step of detecting whether the current date is the target date is performed, and the festival query identifier corresponding to the user is set to be 0. At a fixed time every day, such as 00:00, the festival query identifier is reset to 1, to ensure that a festival query command is queried only once per user per day. If the target text is obtained, the target text is added to the basic text. That is to say, the target text is spliced to the front or back of the basic text to obtain the broadcast text.

For all speech application scenarios, the above method can be used to generate the broadcast text. There are subtle differences in broadcast speeches in different service regions, but the overall idea is to obtain key service information, obtain corresponding service information (basic text), and then combine the speaker's age and festival information to generate the final broadcast text.

Step S3206: Digital human data is generated based on the speech feature and image data corresponding to the digital human identifier and the broadcast text.

A digital human generation algorithm of is a generative adversarial network. The generative adversarial network is a neural network model composed of a generator and a discriminator. The generator is responsible for generating realistic digital human images, while the discriminator is responsible for determining whether the images generated are real or fake. Through continuous confrontation and learning, the generator can gradually generate more realistic digital human images.

The step of generating digital human data based on the speech feature and avatar data corresponding to the digital human identifier and the broadcast text includes following steps.

The broadcast speech is synthesized according to the speech feature and the broadcast text corresponding to the digital human identifier.

A key point sequence is predicted according to that broadcast speech.

Digital human image data is synthesized according to the key point sequence and the image data corresponding to the digital human identifier. Digital human data includes digital human image data and broadcast speech.

In some embodiments, the digital human avatar data may be decorated according to domain and the intention and/or user emotion type.

Step 3207: The digital human data is sent to the display apparatus 200 for the display apparatus 200 to play the image and speech of the digital human according to the digital human data.

In some embodiments, the digital human image data is an image frame sequence. The server 400 sends the image frame sequence and the broadcast speech to the display apparatus 200 in a live streaming method. The display apparatus 200 displays an image corresponding to the image frame and plays the broadcast speech.

In some embodiments, the digital human image data is a digital human parameter sequence. The server 400 sends the digital human parameter sequence and the broadcast speech to the display apparatus 200. The display apparatus 200 displays the image of the digital human and plays the broadcast speech based on the digital human parameter and the basic model.

In some embodiments, after the display apparatus 200 detects that a duration of entering a target scenario exceeds a preset duration, a timeout message is sent to that server 400. The timeout message includes the target scenario.

After receiving the timeout message, the server 400 generates a prompt text based on the relationship and the target scenario.

Digital human data is generated based on the speech feature and avatar data corresponding to the digital human identifier and the prompt text.

The digital human data is sent to the display apparatus for the display apparatus to play the image and speech of the digital human according to the digital human data.

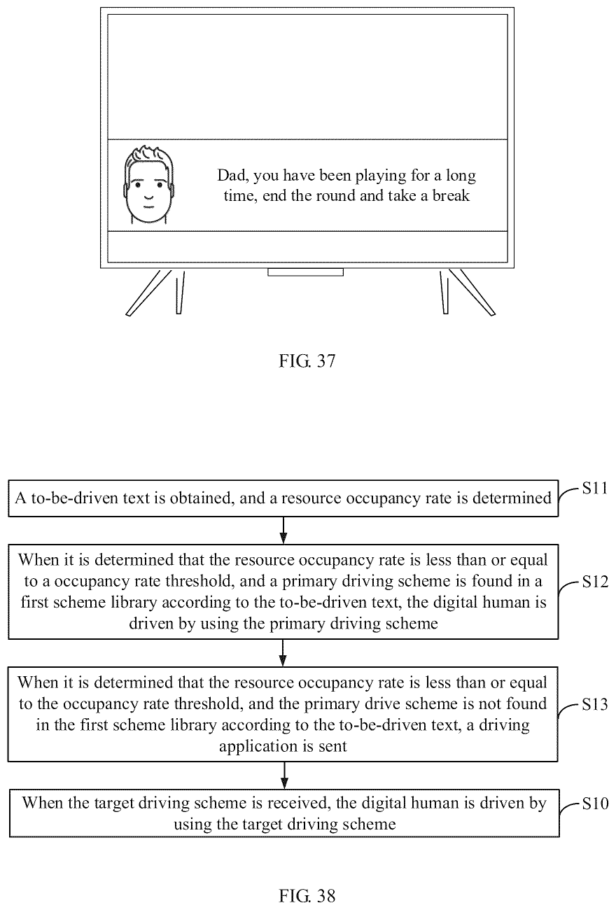

In some embodiments, the user says “I want to play mahjong,” the digital human broadcasts “Dad, come and show them your excellent winning skills”. When it is detected that the time of staying in the mahjong interface exceeds 1 hour, a timeout message is uploaded to the server 400. Digital human data is generated and sent to the display apparatus 200. The display apparatus 200 displays that the digital human broadcasts “Dad, you have been playing for a long time, end the round and take a break”, as shown in FIG. 37.

In embodiments of the present disclosure, a digital human is generated through a real human video recording, and a family relationship graph is established. A kinship between the speaker and the digital human is obtained based on the voiceprint information and the virtual digital human information. Interesting broadcast content like family chat is generated, so that the user can have the feeling of family companionship when using speech, improving user experience.

In addition, considering that in the practical application, in the process of running the digital human, the display apparatus may be stuck and unable to run due to factors such as resources, network, concurrency, etc. For example, the display apparatus may play high-definition video, real-time remote chat and so on at the same time in the process of running the digital human. These tasks are very resource intensive for the display apparatus, and may cause the display apparatus to be stuck and unable to run when running the digital human, thus affecting the interaction between the user and the digital human. The timeliness and stability of digital human and the user experience are poor. In order to address the problem, embodiments of the present disclosure further add a digital human driving process on the basis of the aforementioned digital human processing method.

The digital human driving process of embodiments of the present disclosure may be performed by the display apparatus 200 or the server 400, and may also be performed by the display apparatus 200 and the server 400 together.

For example, when the display apparatus 200 and the server 400 collectively perform the digital human driving process according to embodiments of the present disclosure, the process is as follows: the display apparatus 200 obtains a to-be-driven text and determines a resource occupancy rate. Then, when determining that the resource occupancy rate is less than or equal to an occupancy rate threshold, and a primary driving scheme is found in a first scheme library according to the to-be-driven text, the digital human is driven by using the primary driving scheme. When determining that the resource occupancy rate is less than or equal to the occupancy rate threshold, and the primary driving scheme is not found in the first scheme library according to the to-be-driven text, a driving application is sent. The first scheme library includes driving texts and driving schemes, one of the driving texts corresponds to one of the driving schemes. The driving application includes an expected level and to-be-driven data for indicating real-time driving of the digital human. When receiving the driving application, the server 400 obtains a current concurrency quantity, and determines a cloud level according to the current concurrency quantity. Then an actual level is then determined based on the expected level and the cloud level, and a target driving scheme is determined according to the actual level and the to-be-driven data. Finally, the server 400 controls the display apparatus 200 to drive the digital human using the target driving scheme. Situations of stutter and incapability of running when the digital human is driven due to resource factors and concurrent factors are avoided, and the user experience is improved.

To facilitate the description of the digital human driving process of embodiments of the present disclosure, subsequently, a performing entity that performs the digital human driving process is called a digital human driving apparatus. The digital human driving apparatus of embodiments of the present disclosure has an application of a first application stored therein, and data such as an operating system of the digital human driving apparatus.

Next, taking the display apparatus 200 as a digital human driving apparatus as example, the digital human driving process according to embodiments of the present disclosure is described as shown in FIG. 38. The digital human driven flow may include following steps.

Step S11: A to-be-driven text is obtained, and a resource occupancy rate is determined.

The to-be-driven text is obtained by converting to-be-driven data. The to-be-driven data is a command for driving the digital human input from the user. For example, the to-be-driven data may be text, speech, or other commands.

Firstly, the to-be-driven text is obtained.

In some embodiments, the way for obtaining the to-be-driven text may be that when the digital human driving apparatus receives the digital human driving command, firstly, the speech content input from the user is obtained, and then the speech content is subjected to text conversion to obtain the to-be-driven text.

In some other embodiments, the way for obtaining the to-be-driven text can also be that after receiving the to-be-driven text, the digital human driving apparatus determines that the user needs to drive the digital human, that is, the digital human driving apparatus directly receives the to-be-driven text, and no speech-to-text conversion process is required.

Of course, the digital human driving apparatus may also receive other forms of to-be-driven data. The to-be-driven data can be converted into the to-be-driven text in the digital human driving apparatus, which is not limited in the present disclosure.

Secondly, after the to-be-driven text is obtained, a resource occupancy rate is determined.

The resource occupancy rate may be a resource occupancy rate of a central processing unit (CPU), may also be a resource occupancy rate of a graphics processing unit (GPU), and may also be an average of the resource occupancy rate of the CPU and the resource occupancy rate of the GPU, or a resource occupancy rate of another processing unit, or combinations thereof, which is not limited by the present disclosure.

The way for determining the resource occupancy rate may be to count the real-time resource occupancy rate at a fixed period. After obtaining the to-be-driven text, an average value of a plurality of real-time resource occupancy rates in a preset time period is used as a final resource occupancy rate. For example, the way for determining the resource occupancy may be to count the real-time resource occupancy every 500 milliseconds (ms). After obtaining the to-be-driven text, the real-time resource occupancy rate 3 seconds(s) before the current moment (i.e., the moment when the to-be-driven text is obtained) is read, and the average value is calculated, to obtain the final resource occupancy rate.

Step S12: When it is determined that the resource occupancy rate is less than or equal to a occupancy rate threshold, and a primary driving scheme is found in a first scheme library according to the to-be-driven text, the digital human is driven by using the primary driving scheme.

Firstly, it should be noted that the digital human according to embodiments of the present disclosure is a 3D digital human, and the digital human driving process in the present disclosure is used to drive the head of the 3D digital human. The first scheme library includes driving texts and driving schemes, and one of the driving texts corresponds to one of the driving schemes. Each driving scheme includes at least one blendshape component, and one blendshape component corresponds to one weight value. Each blendshape component is used to show a portion of a digital human's head (e.g., eyes, eyebrows, mouth, etc.) The change of the weight value corresponding to the blendshape component can control the degree of influence of the blendshape component in the animation. That is, by changing the weight value of the blendshape component, an expression or deformation can be generated on the part of the digital human corresponding to the blendshape component.

A blendshape algorithm in embodiments of the present disclosure is a technology used in computer animation and 3D modeling, and is often used to create realistic facial expressions and character morphs. Expression change and animation control of the digital human by using the blendshape algorithm can be as follows: firstly, the digital human needs to be modeled, that is, a complete body model of digital human needs to be created, including the geometry of bone structure and skin surface. Then, a head blendshape model is created (the head blendshape model includes a plurality of blendshape components, each blendshape component shows a portion of the digital human's head, e.g., eyes, eyebrows, mouth, etc.), and is used for controlling change of the facial expression of the digital human. Next, a weight value for each blendshape component is set, to control an influence degree of each blendshape component on the animation. The weight value can be adjusted by programming or a control panel in animation software. After that, the traditional skeletal animation technology is used to control the posture, action and movement of the digital human. After that, on the basis of skeletal animation, the weight of blendshape component is used to control the change of the facial expression of the digital human. That is to say, by changing the weight value of the blendshape component of the face, the expression change can be realized to meet the specific action requirements. Finally, the digital human subjected to facial expression change by the blendshape component is rendered in a rendering engine in real time, to represent as a realistic, full-body animation. The rendering engine can interpolate and deform the geometric shape of the face of the digital human model according to the weight value of the blendshape component, to produce smooth transitions and natural animations.

In some embodiments, the occupancy threshold in embodiments of the present disclosure is preset. For example, the occupancy threshold is a default value, or, the occupancy threshold is a value determined by relevant person according to an actual situation of the digital human driving apparatus.

Secondly, when the resource occupancy rate is determined to be less than or equal to the occupancy rate threshold, and the primary driving scheme is found in the first scheme library according to the to-be-driven text, the digital human is driven by using the primary driving scheme.

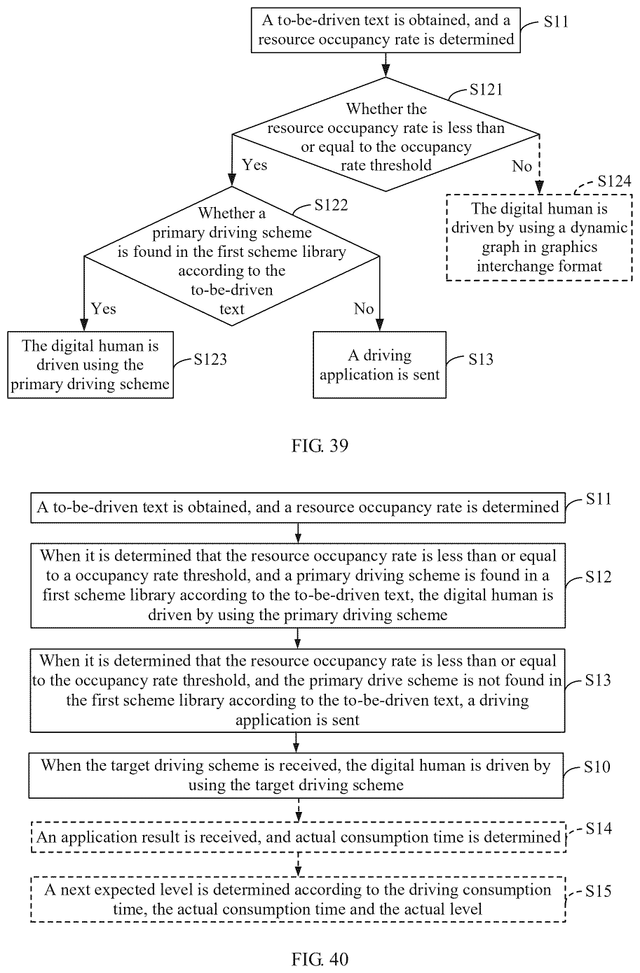

As shown in FIG. 39, when it is determined that the resource occupancy rate is less than or equal to the occupancy rate threshold, and the primary driving scheme is found in the first scheme library according to the to-be-driven text, driving the digital human using the primary driving scheme may include following steps.

Step S121: Whether the resource occupancy rate is less than or equal to the occupancy rate threshold is determined. When the resource occupancy rate is less than or equal to the occupancy rate threshold, the step S122 is performed. When the resource occupancy rate is greater than occupancy rate threshold, step S124 is performed.

Step S122: Whether a primary driving scheme is found in the first scheme library according to the to-be-driven text is determined. When the primary driving scheme is found in the first scheme library according to the to-be-driven text, step S123 is performed. When the primary driving scheme is not found in the first scheme library according to the to-be-driven text, step S13 is performed.

In some embodiments, before matching the primary drive scheme in the first scheme library according to the to-be-driven text, the digital human driven process may further include creating the first scheme library. The way to create the first scheme library may be presetting a plurality of driving texts and driving schemes corresponding to the driving texts in the scheme library to obtain the first scheme library.

Step S123: The digital human is driven using the primary driving scheme.

The primary driving scheme in the present disclosure includes at least one blendshape component, and one blendshape component corresponds to one weight value. When the digital human is driven by using the primary driving scheme, the weight value of each blendshape component in the digital human model is adjusted according to the weight value corresponding to each blendshape component in the primary driving scheme, to realize the facial expression change of the digital human.

Step S124: The digital human is driven by using a dynamic graph in graphics interchange format (GIF).

When the resource occupancy rate is greater than the occupancy rate threshold, it is

determined that the digital human driving apparatus runs more tasks, and resources are relatively tight. At this time, the digital human is driven by the GIF dynamic graph to for avatar display, and switching of the viewing angle is not supported in this driving mode, meet the minimum resource presentation settings.

In the above scheme, after obtaining the to-be-driven text, the digital human driving apparatus determines that the digital human needs to be driven, and the resource occupancy rate is determined. Then, when determining that the resource occupancy rate is less than or equal to the occupancy rate threshold, and the primary driving scheme is found in the first scheme library according to the to-be-driven text, the digital human is driven by using the primary driving scheme. In this way, when the digital human driving apparatus determines that the digital human needs to be driven, the digital human driving apparatus first determines its own resource occupancy rate, and when the resource occupancy rate is in different ranges, different driving schemes are used to drive the digital human, avoiding situations of stutter and incapability of running when the digital human is driven due to resource factors, and improving the user experience. In addition, when it is determined that the resource occupancy rate is in an appropriate range and the primary driving scheme can be found in the first scheme library, the primary driving scheme is directly used to drive digital human, saving the resource loss of cloud real-time driving and the time loss of network transmission.

S13: When it is determined that the resource occupancy rate is less than or equal to the occupancy rate threshold, and the primary drive scheme is not found in the first scheme library according to the to-be-driven text, a driving application is sent.

The driving application includes the expected level and the to-be-driven data for indicating the real-time driving of the digital human. The expected level is determined based on the expected level, driving time, actual time, and the actual level, corresponding to the last time the digital human was driven. An initial value of the expected level may be a middle level. For example, when the highest level of the expected level is level 3, the initial value of the expected level may be level 2. When the highest level of the expected level is level 4, the initial value of the expected level may be level 2 or level 3.

When it is determined that the resource occupancy rate is less than or equal to the occupancy rate threshold, and the primary drive scheme is not matched in the first scheme library according to the to-be-driven text, it is determined that no suitable drive scheme is currently available for driving the digital human, and it is necessary to determine a driving scheme to drive the digital human according to real-time analysis of the to-be-driven data. At this time, a driving application is sent to the server to request the server to drive the digital human in real time according to the to-be-driven text.

In the above scheme, when the resource occupancy rate is determined to be less than or equal to the occupancy rate threshold, and the primary drive scheme is not matched in the first scheme library according to the to-be-driven text, a driving application is sent to the server, to request the server to drive the digital human in real time according to the to-be-driven text. Different driving entities can be adaptively switched according to the resource condition, and thus the optimal driving effect is pursued while ensuring the timeliness, improving the user experience.

Step S10: When the target driving scheme is received, the digital human is driven by using the target driving scheme.

The weight value of the blendshape component of the digital human is adjusted according to the weight value corresponding to the blendshape component in the target driving scheme, to realize facial expression change of the digital human, so that the digital human realizes the specific expression change corresponding to the driving feature.

In some embodiments, as shown in FIG. 40, after sending the driving application, the digital human driving process further includes following steps.

Step S14: An application result is received, and actual consumption time is determined.

The application result includes the actual level and driving time. The actual consumption time is a duration between sending the driving application and receiving the application result.

The digital human driving apparatus records consumption time between sending the driving application and receiving the application result, determines the consumption time as the actual consumption time.

Step S15: A next expected level is determined according to the driving consumption time, the actual consumption time and the actual level.

The next expected level is an expected level corresponding to next time the digital human is driven.

In some embodiments, as shown in FIG. 41, the method of determining the next expected level based on the driving consumption time, the actual consumption time, and the actual level may include following steps.

Step S151: Network consumption time is calculated according to the driving consumption time and the actual consumption time.

The network consumption time can be calculated according to following formula: Network_T=Total_T-Driver_T. Network_T is used for representing the network consumption time, Total_T is used for representing the actual consumption time, and Driver_T is used for representing the driving consumption time.

Step S152: Whether the network consumption time is greater than a first time threshold is determined, when the network consumption time is greater than first time threshold, step S1521 is performed, and when the network consumption time is less than or equal to the first time threshold, step S153 is performed.

Step S1521: The next expected level is determined to be the actual level minus one.

Step S153: Whether the network consumption time is greater than a second time threshold is determined, when the network consumption time is greater than the second time threshold, step S1531 is performed, and when the network time is less than or equal to the second time threshold, step S1532 is performed.

The second time threshold is less than first time threshold.

Step S1531: The next expected level is determined to be the actual level.

Step S1532: The next expected level is determined to be the actual level plus one.

When Network_T>Thr_T1, it is determined that the next expected level is the actual level minus one. When Thr_T1≥Network_T>Thr_T2, the next expected level is determined to be the actual level. When Network_T≤Thr_T2, the next expected level is determined to be the actual level plus one. Network_T is used for representing the network consumption time, Thr_T1 is used for representing the first time threshold, and Thr_T2 is used for representing the second time threshold.

In the above scheme, the next expected level is adaptively adjusted according to the application result and the actual consumption time. A circular decision-making strategy can be formed through real-time information interaction between the display apparatus and the server. High real-time sub-level switching can be achieved to alleviate network congestion or sudden increase of access concurrency in time, ensuring the user has a smoother experience. Additionally, the actual level is determined based on the network consumption time, avoiding situations of stutter and incapability of running when the digital human is driven due to network factors, and improving the user experience.

In following embodiments, taking a performing entity of the digital human driving process according to embodiments of the present disclosure as the digital human driving apparatus on the server side as an example, the method of embodiments of the present disclosure is described.

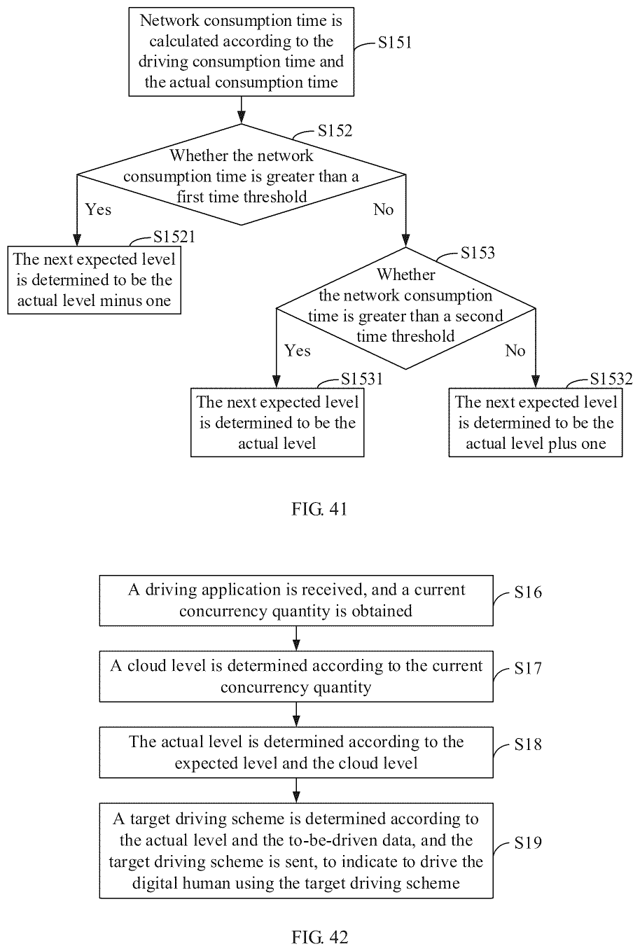

Next, the digital human driving process according to embodiments of the present disclosure is described by taking the server 400 as a digital human driving apparatus. As shown in FIG. 42, the digital human driving process may include following steps.

Step S16: A driving application is received, and a current concurrency quantity is obtained.

The driving application includes an expected level and to-be-driven data.

When receiving the driving application, it is determined that the digital human needs to be driven in real time to obtain the current concurrency quantity.

In some embodiments, the current concurrency quantity may be obtained by counting the quantity of requests over a period of time in real time, and taking the quantity of requests as the current concurrency quantity. For example, the quantity of requests in the last 1s is counted in real time, and the quantity of requests is determined as the current concurrency quantity.

Step S17: A cloud level is determined according to the current concurrency quantity.

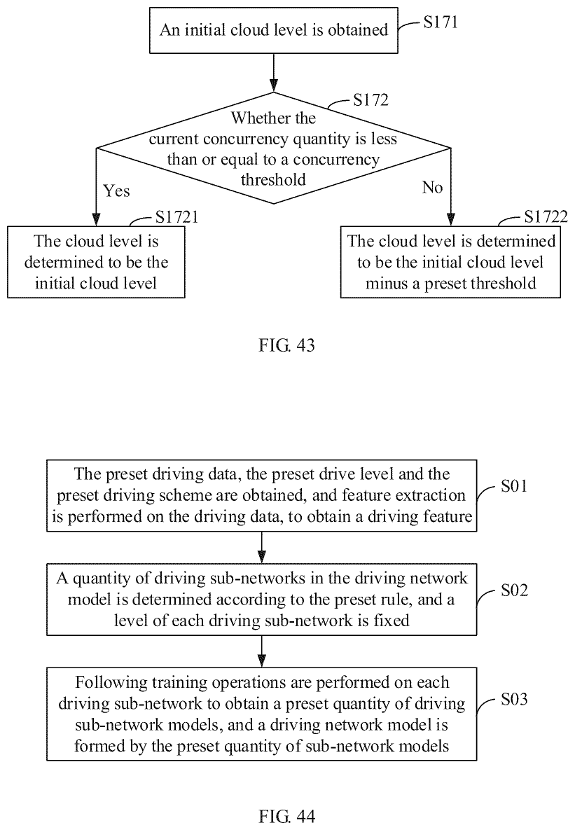

In some embodiments, as shown in FIG. 43, determining the cloud level according to the current concurrency quantity may include following steps.

Step S171: An initial cloud level is obtained.

The initial cloud level is preset, for example, the initial cloud level is the highest level.

Step S172: Whether the current concurrency quantity is less than or equal to a concurrency threshold is determined. When the current concurrency quantity is less than or equal to the concurrency threshold, step S1721 is performed. When the current concurrency quantity is greater than the concurrency threshold, step S1722 is performed.

The concurrency threshold is a positive integer.

Step S1721: The cloud level is determined to be the initial cloud level.

Step S1722: The cloud level is determined to be the initial cloud level minus a preset threshold.

The current concurrency quantity is annotated by N1, and the concurrency threshold is represented by n. When N1≤n, the cloud level is determined to be the initial cloud level. When N1>n, the cloud level is determined to be the initial cloud level minus the preset threshold. The preset threshold is a preset positive integer, and can be a default value or a numerical value set by relevant person according to the actual situation.

In some embodiments, the concurrency threshold includes a first concurrency threshold and a second concurrency threshold. The preset threshold includes a first preset threshold and a second preset threshold. The first concurrency threshold is less than the second concurrency threshold. The first preset threshold is greater than the second preset threshold. The first concurrency threshold, the second concurrency threshold, the first preset threshold, and the second preset threshold are all positive integers. Determining the cloud level according to the current concurrency quantity may also be: when N1≤n1, the cloud level is determined to be the initial cloud level; when n2≥N1>n1, the cloud level is determined to be the initial cloud level minus the first preset threshold; when N1>n2, the cloud level is determined to be the initial cloud level minus the second preset threshold. N1 is used for representing the current concurrency quantity, n1 is used for representing the first concurrency threshold, and n2 is used for representing the second concurrency threshold.

Of course, the quantity of concurrency thresholds and the quantity of preset thresholds can be set according to the computing power of the hardware device, which are not limited in the present disclosure.

Step S18: The actual level is determined according to the expected level and the cloud level.

In some embodiments, the method in which the actual level is determined based on the expected level and the cloud level may be that: the actual level may be determined to be the minimum of the expected level and the cloud level.

Step S19: A target driving scheme is determined according to the actual level and the to-be-driven data, and the target driving scheme is sent, to indicate to drive the digital human using the target driving scheme.

In some embodiments, at least one blendshape component is included in the target drive scheme, and one blendshape component corresponds to one weight value.

In some embodiments, the method in which the target driving scheme is determined based on the actual level and the to-be-driven data may be that: the to-be-driven data and the actual level can be input into a driving network model for scheme extraction processing to obtain the target driving scheme. The driving network model is obtained through training by taking preset driving data and a preset driving level as input, and a preset driving scheme as output.

Before the to-be-driven data and the actual level are input into the driven network model for scheme extraction processing to obtain the target driving scheme, the digital human driving process further includes training and generating the driving network model according to the preset driving data, the preset driving level and the preset driving scheme.

As shown in FIG. 44, the method of training and generating the driving network model according to the preset driving data, the preset driving level, and the preset driving scheme may include following steps.

Step S01: The preset driving data, the preset drive level and the preset driving scheme are obtained, and feature extraction is performed on the driving data, to obtain a driving feature.

Firstly, the method for obtaining the preset driving data and the preset driving scheme may be invoking historical driving data input from a user in a certain historical time period and the corresponding driving scheme, and may also be the driving data and the corresponding driving scheme simulated by a preset apparatus, which is not limited in the present disclosure.

The method of obtaining the preset driving level may be determining according to a preset rule and a quantity of blendshape components in the preset driving scheme. The preset rule includes a corresponding relationship between the driving level and the quantity of blendshape components in the driving scheme. For example, the preset rule may be that: when P≤n, the preset driving level is determined to be level one, when n<P≤m, the preset driving level is determined to be level two, and when m<P, the preset driving level is determined to be level three. P is used for representing the quantity of blendshape components in the driving scheme and m>n. For another example, the preset rule may be that: when P≤n, the preset driving level is determined to be level one, when n<P≤m−i, the preset driving level is determined to be the level two, when m−i<P≤m, the preset driving level is determined to be level three, when m<P, the preset driving level is determined to be level four. Where n<m−i<m. The present disclosure does not limit the quantity of driving levels in the preset rule.

Then, feature extraction is performed on the driving data to obtain the driving feature.

In some embodiments, the method for performing feature extraction on to-be-driven data can be performing feature extraction on the to-be-driven data by using a feature extraction algorithm to obtain the driving feature. For example, the feature extraction algorithm may be a Mel frequency cepstral coefficients (MFCC) algorithm, or, filter bank feature (fbank) algorithm.

Step S02: A quantity of driving sub-networks in the driving network model is determined according to the preset rule, and a level of each driving sub-network is fixed.

The quantity of the driving sub-networks in the driving network model is determined according to the quantity of driving levels in the preset rule. For example, if the quantity of driving levels in the preset rule is 3, then the quantity of driving sub-networks is also 3.

The way to fix the level of each driving sub-network may be that one driving sub-network corresponds to one driving level, and driving levels of any two driving sub-networks are different.

Step S03: Following training operations are performed on each driving sub-network to obtain a preset quantity of driving sub-network models, and a driving network model is formed by the preset quantity of sub-network models.

The training operations include: for a target driving sub-network, a preset driving level equal to a driving level of the target driving sub-network, and a corresponding driving feature are used as input of the target driving sub-network, and a corresponding preset driving scheme is used as output of the target driving sub-network, to train the target driving sub-network for n times until a loss function of the target driving sub-network converges, and obtain a driving sub-network model corresponding to the target driving sub-network. The target driving sub-network is any one driving sub-network.

After the driving network model is trained and generated, the to-be-driven data and the actual level are input into the driving network model for scheme extraction processing, to obtain a target driving scheme.

In the above scheme, after receiving the driving application, the digital human driving apparatus obtains the current concurrency quantity, and determines the cloud level according to the current concurrency quantity. The actual level is then determined based on the expected level in the driving application and the cloud level, and a target driving scheme is determine according to the actual level and the to-be-driven text. Finally, the target driving scheme is used to drive the digital human. In this way, when the display apparatus determines that the resource occupancy rate is in the appropriate range but the primary driving scheme cannot be found in the first scheme library, the display apparatus sends a driving application to the server so that the server controls the display apparatus to drive the digital human in real time. After receiving the driving application, the server first determines its own concurrency quantity. When the concurrency quantity meets the condition, then the server controls the display apparatus to drive the digital human in real time, avoiding situations of stutter and incapability of running when the digital human is driven due to concurrency factors, and improving the user experience.

In some embodiments, after sending the target driving scheme, the digital human driving process further includes returning an application result. The application result includes an actual level and driving consumption time, and is used for indicating determination of a next expected level.

In some embodiments, the digital human driving apparatus needs to return the application result after sending the target driving scheme. The application result is used for indicating determination of the next expected level, including the actual level and the driving consumption time.

Therefore, the next expected level can be adaptively adjusted according to the application result and the actual consumption time. A circular decision-making strategy can be formed through real-time information interaction between the display apparatus and the server. High real-time sub-level switching can be achieved to alleviate network congestion or sudden increase of access concurrency in time, ensuring the user has a smoother experience.

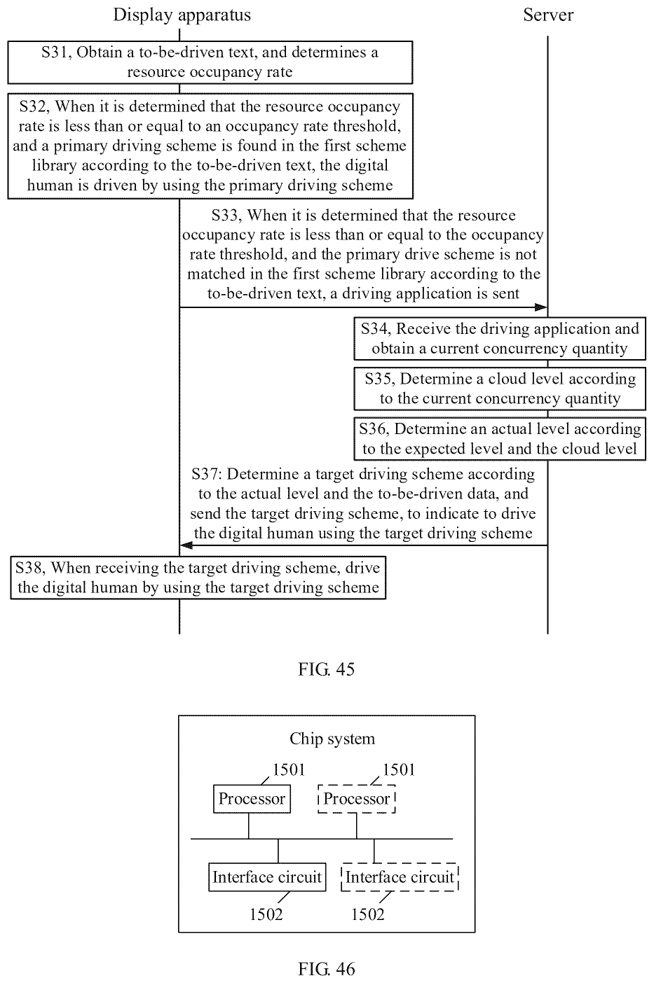

Next, the display apparatus 200 and the server 400 are used as the digital human driving apparatus at the same time, to describe the digital human driving process according to embodiments of the present disclosure as shown in FIG. 45. The digital human driven process may include following steps.

S31: The display apparatus obtains a to-be-driven text, and determines a resource occupancy rate.

The to-be-driven text is obtained by converting to-be-driven data.

S32: When the display apparatus determines that the resource occupancy rate is less than or equal to an occupancy rate threshold, and a primary driving scheme is found in the first scheme library according to the to-be-driven text, the digital human is driven by using the primary driving scheme.

The first scheme library includes driving texts and driving schemes, and one of the driving texts corresponds to one of the driving schemes.

S33: When the display apparatus determines that the resource occupancy rate is less than or equal to the occupancy rate threshold, and the primary drive scheme is not matched in the first scheme library according to the to-be-driven text, a driving application is sent.

The driving application includes the expected level and the to-be-driven data for indicating to drive the digital human in real time.

S34: The server receives the driving application and obtains a current concurrency quantity.

The driving application includes the expected level and the to-be-driven data.

S35: The server determines a cloud level according to the current concurrency quantity.

S36: The server determines an actual level according to the expected level and the cloud level.

S37: The server determines a target driving scheme according to the actual level and the to-be-driven data, and sends the target driving scheme, to indicate to drive the digital human using the target driving scheme.

S38: When receiving the target driving scheme, the display apparatus drives the digital human by using the target driving scheme.

Implementations of embodiments of the present disclosure are the same as implementations of the digital human driving process performed by the digital human driving apparatus on the display apparatus side and the digital human driving apparatus on the server side. Therefore, the specific implementations may be with reference to implementations of the digital human driving process performed by the digital human driving apparatus on the display apparatus side and the digital human driving apparatus on the server side, and will not be repeated here.

In the above process, after obtaining the to-be-driven text, the display apparatus determines that the digital human needs to be driven, and determines the resource occupancy rate. When determining that the resource occupancy rate is less than or equal to the occupancy rate threshold, and the primary driving scheme is found in the first scheme library according to the to-be-driven text, the digital human is driven by using the primary driving scheme. In this way, when the display apparatus determines that the digital human needs to be driven, the display apparatus first determines its own resource occupancy rate, and drives the digital human when the resource occupancy is in the appropriate range, avoiding situations of stutter and incapability of running when the digital human is driven due to resource factors, and improving the user experience. In addition, when it is determined that the resource occupancy rate is in an appropriate range and the primary driving scheme can be found in the first scheme library, the primary driving scheme is directly used to drive digital human, saving the resource loss of cloud real-time driving and the time loss of network transmission.

Further, if the display apparatus determines that the primary driving scheme is not found in the first scheme library according to the to-be-driven text, a driving application is sent. After receiving the driving application, the server obtains the current concurrency quantity and determines the cloud level according to the current concurrency quantity. The actual level is then determined according to the expected level in the driving application and the cloud level, and a target driving scheme is determined according to the actual level and the to-be-driven data. Finally, the server sends the target driving scheme to the display apparatus, and the display apparatus uses the target driving scheme to drive the digital human. In this way, when the display apparatus determines that the resource occupancy rate is in the appropriate range but the primary driving scheme cannot be found in the first scheme library, the display apparatus sends a driving application to the server so that the server controls the display apparatus to drive the digital human in real time. After receiving the driving application, the server first determines its own concurrency quantity, and when the concurrency quantity meets the condition, then controls the display apparatus to drive the digital human in real time, avoiding situations of stutter and incapability of running when the digital human is driven due to concurrency factors, and improving the user experience.

In embodiments of the present disclosure, the digital human driving apparatus may be divided into functional modules according to the above method examples. For example, each function module can be divided corresponding to each function, or two or more functions can be integrated in one processing unit. The integrated modules may be implemented in the form of hardware or software functional modules. It should be noted that division of modules in embodiments of the present disclosure is schematic and is only a division of logical functions. In actual implementation, there may be other ways of division.

As shown in FIG. 46, embodiments of the present disclosure further provide a chip system. The chip system can be applied to the digital human driving apparatus on the display apparatus side or the digital human driving apparatus on the server side in the foregoing embodiments. The chip system includes at least one processor 1501 and at least one interface circuit 1502. The processor 1501 and the interface circuit 1502 may be interconnected by wires. The processor 1501 may receive and execute computer instructions from the digital human driving apparatus on the display apparatus side or the digital human driving apparatus on the server side through the interface circuit 1502. When the computer instructions are executed by the processor 1501, the digital human driving apparatus on the display apparatus side or the digital human driving apparatus on the server side may be enabled to perform steps performed by the digital human driving apparatus on the display apparatus side or the digital human driving apparatus on the server side in the above embodiment. Of course, the chip system may further include other discrete devices, which are not limited in embodiments of the present disclosure.

What is claimed is:

1. A server, configured to:
receive speech data input from a user and sent from a display apparatus;
recognize the speech data to obtain a recognition result;
based on that the recognition result comprises entity data, obtain media resource data corresponding to the recognition result, and digital human data corresponding to the entity data;
wherein the entity data comprises a human name and/or a media resource name, the digital human data comprises image data and a broadcast speech of a digital human, and the media resource data comprises audio and video data or interface data; and
send the digital human data and the media resource data to the display apparatus for the display apparatus to play the audio and video data or display the interface data, and play an image and a speech of the digital human according to the digital human data;
wherein the server is further configured to:
before receiving the speech data input from the user and sent from the display apparatus, generate a drawing model corresponding to at least one human name, generate an action model corresponding to at least one media resource name, and generate a speech synthesis model based on tone and rhythm and corresponding to the at least one human name;
input the drawing model, the action model, and the speech synthesis model into a conditional adversarial network trained to obtain to-be-stored digital human data;
perform feature annotation on the to-be-stored digital human data and store the to-be-stored digital human data after the feature annotation into the server;
wherein the server performing the feature annotation on the to-be-stored digital human data and store the to-be-stored digital human data after the feature annotation into the server is configured to:
annotate human information, a media resource name and a popularity degree of the to-be-stored digital human data; wherein the human information comprises a human name, and the popularity degree is a quantity of pieces of training data;
obtain a first popularity degree and a second popularity degree; wherein the first popularity degree is the highest popularity degree corresponding to the human name in digital human data stored, the second popularity degree is the highest popularity degree corresponding to the media resource name in the digital human data stored;
based on that the popularity degree of the to-be-stored digital human data is not less than the first popularity degree or the second popularity degree, store the to-be-stored digital human data annotated into the server.

2. The server according to claim 1, wherein the server generating the drawing model corresponding to the at least one human name is configured to:
obtain a preset quantity of images corresponding to the human name;
input the images into a text-to-image model to obtain the drawing model corresponding to the human name.

3. The server according to claim 1, wherein the server generating the action model corresponding to the at least one media resource name is configured to:
obtain a preset quantity of pieces of sample video data, and preprocess and annotate the sample video data;
train an action generation model by using the sample video data annotated;
input video data corresponding to the media resource name into the action generation model trained, to generate the action model corresponding to the media resource name.

4. The server according to claim 1, wherein the server generating the speech synthesis model based on tone and rhythm and corresponding to the at least one human name is configured to:
obtain a preset quantity of pieces of sample audio data, and preprocess and annotate the sample audio data; wherein the sample audio data comprises audio data corresponding to the human name and audio data corresponding to the media resource name;
train the speech synthesis model by using the sample audio data annotated to obtain the speech synthesis model based on tone and rhythm and corresponding to the human name.

5. The server according to claim 1, wherein the server obtaining the digital human data corresponding to the entity data is configured to:
based on that the recognition result comprises the human name or the media resource name, obtain the digital human data, in digital human data stored, with a feature annotated as the human name or the media resource name.

6. The server according to claim 1, wherein the server obtaining the digital human data corresponding to the entity data is configured to:
based on that the recognition result comprises the human name and the media resource name, and the human name and the media resource name do not match feature annotations in digital human data stored, replace a drawing model corresponding to the media resource name with a drawing model corresponding to the human name, and replace speech data corresponding to the media resource name with speech data corresponding to the human name, to generate digital human data replaced;
determine the digital human data replaced as the digital human data corresponding to the human name and the media resource name.

7. The server according to claim 1, wherein the server is further configured to:
after receiving the speech data sent from the display apparatus, obtain a speech text by recognizing the speech data;
perform semantic understanding on the speech text to obtain a domain and intention corresponding to the speech data;
determine the broadcast speech based on the domain and intention, and determine a digital human avatar parameter based on the domain and intention; wherein the digital human avatar parameter is used for generating the image of the digital human and/or generating an action of the digital human;
generate the digital human data based on the digital human avatar parameter and the broadcast speech; send the digital human data to the display apparatus for the display apparatus to play the image and speech of the digital human according to the digital human data.

8. The server according to claim 7, wherein the server is further configured to:
determine a user emotion type corresponding to the speech data;
wherein the server determining the digital human avatar parameter based on the domain and intention is configured to:
determine the digital human avatar parameter based on the user emotion type and the domain and intention.

9. The server according to claim 8, wherein the server determining the user emotion type corresponding to the speech data is further configured to:
determine the user emotion type corresponding to the speech data based on the speech data.

10. The server according to claim 7, wherein the server determining the digital human avatar parameter based on the domain and intention is configured to:
search a digital human avatar mapping table for a digital human avatar identifier corresponding to the domain and intention; wherein the digital human avatar mapping table is used for representing a corresponding relationship between the domain and intention and the digital human avatar identifier;
search a digital human definition table for a digital human avatar parameter corresponding to the digital human avatar identifier; wherein the digital human definition table is used for representing a corresponding relationship between the digital human avatar identifier and the digital human avatar parameter, and the digital human avatar parameter comprises a decoration parameter and an action parameter.

11. The server according to claim 1, wherein the server is further configured to:
after receiving the speech data sent from the display apparatus, input the speech data into an emotion speech model to obtain an emotion type and an emotion intensity; wherein the emotion speech model is obtained by training based on sample speech data of different groups of humans for a plurality of semantic scenarios;
obtain a broadcast text corresponding to the speech data;
synthesize the broadcast speech based on the broadcast text, the emotion type and the emotion intensity;
send the broadcast speech to the display apparatus for the display apparatus to play the broadcast speech.

12. The server according to claim 1, wherein the server is further configured to:
receive the speech data from the display apparatus and a digital human identifier; wherein the digital human identifier is used for representing a digital human avatar and a speech feature selected by the user;
determine user identity information corresponding to the speech data, and obtain a speech text by recognizing the speech data;
determine a relationship between the digital human and the user based on the digital human identifier and the user identity information;
determine a basic text according to the speech text, wherein the basic text is obtained by performing natural language processing on the speech text;
generate a broadcast text based on the basic text and the relationship;
generate the digital human data based on a speech feature and avatar data corresponding to the digital human identifier and the broadcast text;
send the digital human data to the display apparatus for the display apparatus to play the image and speech of the digital human according to the digital human data.

13. The server according to claim 12, wherein the server determining the user identity information corresponding to the speech data is configured to:
extract voiceprint information of the speech data;
based on that the voiceprint information matches with voiceprint information registered in a voiceprint library, determine the user identity information according to the voiceprint information registered.

14. The server according to claim 12, wherein the server determining the basic text according to the speech text is configured to:
perform word segmentation and annotation processing on the speech text to obtain word segmentation information;
perform syntactic analysis and semantic analysis on the word segmentation information to obtain slot position information;
position a domain and intention corresponding to the slot position information through vertical domain classification;
determine the basic text based on the domain and intention and the slot position information.

15. The server according to claim 12, wherein the server generating the broadcast text based on the basic text and the relationship is configured to:
obtain splicing information corresponding to the relationship; wherein the splicing information comprises a splicing position and a splicing content, the splicing position comprises pre-splicing, and the splicing content corresponding to the pre-splicing is an appellation set according to the relationship;
generate the broadcast text based on the splicing information and the basic text.

16. The server according to claim 15, wherein the splicing position further comprises post-splicing, the server generating the broadcast text based on the basic text and the relationship is configured to:
obtain an age of the user;
determine the splicing content corresponding to the post-splicing based on the age and the basic text.

17. The server according to claim 12, wherein the server generating the broadcast text based on the basic text and the relationship is configured to:
based on that a date detected is a target date and the target date is related to the relationship, determine a target text according to the relationship; wherein the target date is a festival and/or an anniversary, and the target text comprises a blessing text and/or a reminding text;
add the target text into the basic text to obtain the broadcast text.

18. The server according to claim 12, wherein the server generating the broadcast text based on the basic text and the relationship is configured to:
based on that a date detected is a target date and the target date is related to the user, generate a target text; wherein the target date is a festival and/or an anniversary;
add the target text into the basic text to obtain the broadcast text.

19. The server according to claim 12, wherein the server is further configured to:
after receiving a timeout message uploaded from the display apparatus, generate a prompt text based on the relationship and a target scenario; wherein the timeout message is sent to the server after the display apparatus detects that a duration of entering the target scenario exceeds a preset duration;
generate the digital human data based on the speech feature and avatar data corresponding to the digital human identifier and the prompt text;
send the digital human data to the display apparatus for the display apparatus to play the image and data of the digital human according to the digital human data.

20. The server according to claim 1, wherein the server is further configured to:
establish a connection relationship with the display apparatus and a terminal respectively for the display apparatus and the terminal to establish an association relationship;
after receiving image data and audio data uploaded from the terminal, determine digital human avatar data based on the image data, and determine a digital human speech feature based on the audio data;
send the digital human avatar data to the display apparatus associated with the terminal for the display apparatus to display a digital human image based on the digital human avatar data;
after the digital human image is selected by the user, receive the speech data input from the user and sent from the display apparatus;
generate a broadcast text according to the speech data;
generate the digital human data based on the broadcast text, the digital human speech feature and the digital human avatar data;
send the digital human data to the display apparatus for the display apparatus to play the image and the speech of the digital human according to the digital human data.
